(19) United States
(12) Patent Application Publication
(10) Pub. No.: US 2026/0024457 A1
(43) Pub. Date: Jan. 22, 2026

(54) ADAPTIVE TESTING BASED ON USER MASTERY LEVELS OF EDUCATIONAL STANDARDS USING INTEGRATED PROGRAMMATIC CONTROL AND SPECIALIZED GUIDED AND CONSTRAINED ARTIFICIAL INTELLIGENCE

(71) Applicant: 2hr Learning, Inc., Austin, TX (US)

(72) Inventors: Samy Aboel-Nil, Austin, TX (US); Simon Said, Malta (MT); Ankur Agarwal, Austin, TX (US)

(73) Assignee: 2hr Learning, Inc., Austin, TX (US)

(21) Appl. No.: 19/273,036

(22) Filed: Jul. 17, 2025

Related U.S. Application Data
(60) Provisional application No. 63/672,363, filed on Jul. 17, 2024.

(51) Int. Cl. G09B 7/04; G06N 5/02

(52) U.S. Cl. CPC G09B 7/04; G06N 5/02

(57) ABSTRACT

An adaptive test generation system based on varying mastery levels of the user on educational standards to guide and constrain an AI engine in selecting educational standards for adaptive testing and updating user mastery levels based on real-time responses is disclosed. The method involves receiving a list of eligible standards, the user's knowledge graph, and dependencies between standards. A prompt is generated to direct AI engine in choosing the next educational standard for questioning. The AI engine selects a standard based on current knowledge graph and previous user responses, presents a question, and receives the user's answer. The knowledge graph is updated to reflect user's mastery levels of related standards. The AI engine then selects next standard, considering the updated knowledge graph and interdependencies among standards. This iterative process determines difficulty of subsequent questions and continues until the adaptive test concludes, based on the states of the educational standards involved.

### CROSS-REFERENCE TO RELATED APPLICATION(S)

This application claims the benefit under 35 U.S.C. § 119(e) and 37 C.F.R. § 1.78 of U.S. Provisional Application No. 63/672,363, which is incorporated by reference in its entirety.

### FIELD OF THE INVENTION

The present invention relates in general to the field of electronics, and more specifically to a method of providing a test based on a knowledge graph of a user on educational standards, adjusting the difficulty level of questions in the test in real-time based on the performance of the user, updating the knowledge graph after receiving the response to each question, and deciding when the test should end based on a pre-defined set of rules.

### BACKGROUND OF THE INVENTION

Educational assessments have been a fundamental aspect of academic systems for a long time, acting as essential tools to evaluate student knowledge and identify the most appropriate learning paths. By evaluating a student's understanding of various subjects, educators can place students in courses that match their current level of proficiency, thereby optimizing their learning experience. However, the traditional methods used for these assessments have not evolved significantly over time and have increasingly shown their limitations in effectively addressing the diverse and dynamic needs of modern students and educational content.

Conventionally, assessments have been static, i.e., they consist of a fixed set of questions that remain the same regardless of the student's performance. This static format does not allow for dynamic adjustments, resulting in a one-size-fits-all approach. Such static assessments often fail to accurately capture the student's knowledge level. For example, a student who excels in certain areas but struggles in others might receive an average score that does not reflect their true strengths and weaknesses. Consequently, this can lead to inappropriate placements, where students might find the questions either too challenging or not challenging enough, hindering their academic progress.

Moreover, these conventional assessment tests do not adapt to the rapidly changing landscape of educational content. Traditional tests are typically designed around a fixed curriculum and do not incorporate new content as it becomes available. This lag in updating the test materials means that assessments may not reflect the most current educational standards and topics, further contributing to the misalignment between a student's capabilities and their assigned learning path.

The traditional assessments impact the learning process by failing to personalize the educational experience. When students are not placed according to their precise knowledge levels, they may not engage with the material as effectively, leading to decreased motivation and lower academic outcomes. Additionally, educators and institutions might have to spend additional time and resources to correct these misplacements, which could have been avoided with more adaptive and responsive assessments.

### SUMMARY

In at least one embodiment, a method integrates programmatic control and a guided and constrained Artificial Intelligence (AI) engine to select an educational standard for quizzing a user during an adaptive test and updating mastery levels of the user on educational standards based on real-time responses to each question. One or more processors of a computer system execute code to cause the computer system to perform operations. The computer system receives a list of eligible standards, the user's knowledge graph of standards, and dependencies between standards in the knowledge graph. The computer system generates a prompt to guide and constrain the AI engine to choose an educational standard for the next question to be asked to the user in the adaptive test. The computer system transfers the prompt to the AI engine to guide and constrain the AI engine to select an educational standard based on the current knowledge graph and the user's response received on a previous question, present a question based on the selected standard, receive a response to the presented question by the user, update the knowledge graph based on the received response, where updating the knowledge graph includes updating mastery levels of the user on one or more pre-requisite educational standards linked to the presented question, select the next standard based on the updated knowledge graph and interdependency of the educational standards, and provide a next question, where the level of difficulty of the next question is decided based on the response provided by the user on the first question and updated mastery levels on the educational standards in the knowledge graph. The computer system determines the end of the adaptive test by checking states of the educational standards considered for quizzing the user during the adaptive test.

In at least one embodiment, a system integrates programmatic control and a guided and constrained Artificial Intelligence (AI) engine to select an educational standard for quizzing a user during an adaptive test and updating mastery levels of the user on educational standards based on real-time responses to each question. The system includes one or more processors of a computer system and a memory, coupled to the one or more processors, storing code that, when executed, causes the computer system to perform operations. The computer system receives a list of eligible standards, the user's knowledge graph of standards, and dependencies between standards in the knowledge graph. The computer system generates a prompt to guide and constrain the AI engine to choose an educational standard for the next question to be asked to the user in the adaptive test. The computer system transfers the prompt to the AI engine to guide and constrain the AI engine to select an educational standard based on the current knowledge graph and the user's response received on a previous question, present a question based on the selected standard, receive a response to the presented question by the user, update the knowledge graph based on the received response, where updating the knowledge graph includes updating mastery levels of the user on one or more pre-requisite educational standards linked to the presented question, select the next standard based on the updated knowledge graph and interdependency of the educational standards, and provide a next question, where the level of difficulty of the next question is decided based on the response provided by the user on the first question and updated mastery levels on the educational standards in the knowledge graph. The computer system determines the end of the adaptive test by checking states of the educational standards considered for quizzing the user during the adaptive test.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary adaptive test generation system based on varying mastery levels of the user on educational standards.

FIG. 2 depicts an exemplary adaptive test generation process based on varying mastery levels of the user on educational standards.

FIG. 3 depicts a flowchart showing the details of the steps involved in generating an adaptive test based on varying mastery levels of the user on educational standards, which is an embodiment of the test generation process of FIG. 2.

FIG. 4 depicts an adaptive test completion evaluation process, which is an embodiment of the adaptive test generation system of FIG. 1.

FIG. 5 depicts a knowledge graph upgradation process based on the response provided by the user in an adaptive test, which is an embodiment of the adaptive test generation system of FIG. 1.

FIG. 6 depicts an adaptive test delivery process to the user based on which the knowledge graph will be updated, which is an embodiment of the adaptive test generation system of FIG. 1.

FIG. 7 depicts an exemplary block diagram explaining the potential application areas of the adaptive test generation system.

FIG. 8 depicts an exemplary network environment in which the adaptive test generation system of FIG. 1 and the adaptive test generation process of FIG. 2 may be practiced.

FIG. 9 depicts an exemplary computer system.

### DETAILED DESCRIPTION

The adaptive test generation system and method set forth herein address technical issues with selecting an educational standard for quizzing a user during an adaptive test described herein. Conventionally, manual processes were used to select the educational standard for quizzing the user during the adaptive test and were very tedious and time consuming. The present adaptive test generation system and method utilize an automated system that does not merely automate a manual process or use a conventional system in a conventional way. The present adaptive test generation system and method utilize one or more artificial intelligence (AI) engines and integrate programmatic process management to technologically guide and constrain the one or more AI engines to select the educational standard for quizzing the user during an adaptive test in a completely different way than both any manual process and different than normal use of programs and AI engines. Utilizing specially engineered guidance and control to direct an AI system in solving the technical problems presented below, which require a technical solution. The adaptive test generation system and method described below are not simply engaging a computer to carry out conventional mental processes, but rather change how computers (and AI systems, specifically) operate to achieve the generation results that were not previously possible or were substantially inefficient prior to the adaptive test generation system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its(their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the adaptive test generation system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The adaptive test generation system and method generate decomposed, technically engineered AI prompts to include selected and integral AI engine guidance and constraints. The technically engineered prompts are generated and guided with programmatic, automatic inputs specifically designed to unconventionally guide and constrain an AI engine to select the educational standard for quizzing the user during an adaptive test, perform quality control to retain or automatically discard outputs that do not meet guidance and constraints, and make the desired outputs available for use, such as use by computer system applications. In at least one embodiment, the problem to be solved by the integrated programmatic and AI engine adaptive test generation system and method is uniquely and unconventionally decomposed, and AI prompts are used to solve the decomposed problem. Furthermore, the programmatic inputs to the decomposed AI prompts provide guidance to select the educational standard for quizzing the user during an adaptive test and updating mastery levels of the user on educational standards based on real-time responses to each question

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the adaptive test generation system and method described herein. Thus, the present adaptive test generation system and method described implement an integration of programmatic management over decomposed prompts with engineered AI engine guidance and constraints to affect an improvement in AI, programmatic AI management, and AI integrated with programmatic management technology. The present adaptive test generation system and method allow computer systems to include programmatic management, one or more AI engines, and one or more data sources to select the educational standard for quizzing the user during an adaptive test and updating mastery levels of the user on educational standards based on real-time responses to each question that previously could not be produced with conventionally prompted AI engines or could only be produced by humans utilizing a completely different, time consuming, and tedious process. The adaptive test generation system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

Notwithstanding any provision to the contrary or anything to the contrary in the below pages, the below pages are not limiting and do not describe all embodiments of the adaptive test generation systems and methods. For example, use of the term “invention” does not limit or require the referenced certain features to be present in all embodiments of the invention. Use of absolute-type terms, such as “required,” “must,” “only,” “important,” and so on are not limiting of all embodiments of the adaptive test generation systems and methods and not to be construed as limiting of the embodiments of the adaptive test generation systems and methods described above.

An adaptive test generation system for a user based on varying mastery levels of the user on educational standards to guide and constrain an AI (Artificial Intelligence) engine to select an educational standard for quizzing a user during an adaptive test and updating mastery levels of the user on educational standards based on real-time responses to each question is disclosed. The adaptive test generation system includes an online learning platform that is operatively coupled to an adaptive test assessment module. The online learning platform includes a memory that stores user profile details, a list of standards eligible for the user, a user's knowledge graph, and a user's test response. A collector integrated within the adaptive test assessment module collects the user profile details, a list of standards eligible for the user, a user's knowledge graph, and a user's test response and passes it on to an analyzer to analyze the data and generate insights.

The insights generated by the analyzer are transferred to the prompt generator which utilizes NLP (Natural Language Processing) techniques to generate the prompts, which are further transferred to the AI engine. These prompts guide and constrain the AI engine to select an educational standard for quizzing a user during an adaptive test and updating the mastery levels of the user on educational standards based on real-time responses to each question. The AI engine selects an educational standard based on the current knowledge graph and the user's previous response and presents a question aligned with this standard. After the user responds, the AI engine updates the knowledge graph, which includes adjusting the user's mastery levels on related educational standards. Finally, the AI engine selects the next standard based on the updated knowledge graph and the interdependency of the educational standards. Further, the next question is provided to the user whose level of difficulty is decided based on the response provided by the user on the first question and updated mastery levels on the educational standards in the knowledge graph.

Finally, the AI engine determines whether to end the adaptive test or not. If the response provided by the user is satisfactory and shows that the user has achieved mastery of the specific topic or standard, then the adaptive test can be concluded. On the contrary, if the user's response is not up to the mark, i.e., the user is making mistakes, providing incorrect answers, or facing difficulty in understanding the concepts, then the loop will be repeated and the user will be provided with a next question.

The adaptive test generation system based on the response provided by the user during the adaptive test offers significant advantages by utilizing the AI engine which uses the machine learning algorithm to provide a personalized educational experience. The adaptive test generation system updates the knowledge graph of the user based on the response provided by the user in the adaptive test. By dynamically selecting the next educational standard based on a user's real-time performance and updating the knowledge graph accordingly, the adaptive test generation system ensures that each user is assessed at an appropriate level, promoting efficient learning and mastery of subjects. The inclusion of machine learning algorithms enhances the accuracy and adaptability of the system, making it responsive to individual learning patterns. Additionally, real-time feedback and a variety of question types are provided to different learning styles, improving user engagement and understanding.

The adaptive test generation system based on the response provided by the user during the adaptive test presented herein discloses the generation of the adaptive test by the AI engine to be presented to the user to check the mastery of the user in that topic and upgrade the knowledge graph accordingly. The adaptive test generation system is also equally applicable when the user is provided with a mock test for exams like SAT, GRE, TOEFL, etc., practice test for self-learning or preparation for exams, test while entering any university/school/college to check the user's academic level, assessment for personalized learning, certification, licensing, test for corporate training to know the knowledge level of the employee, and so on.

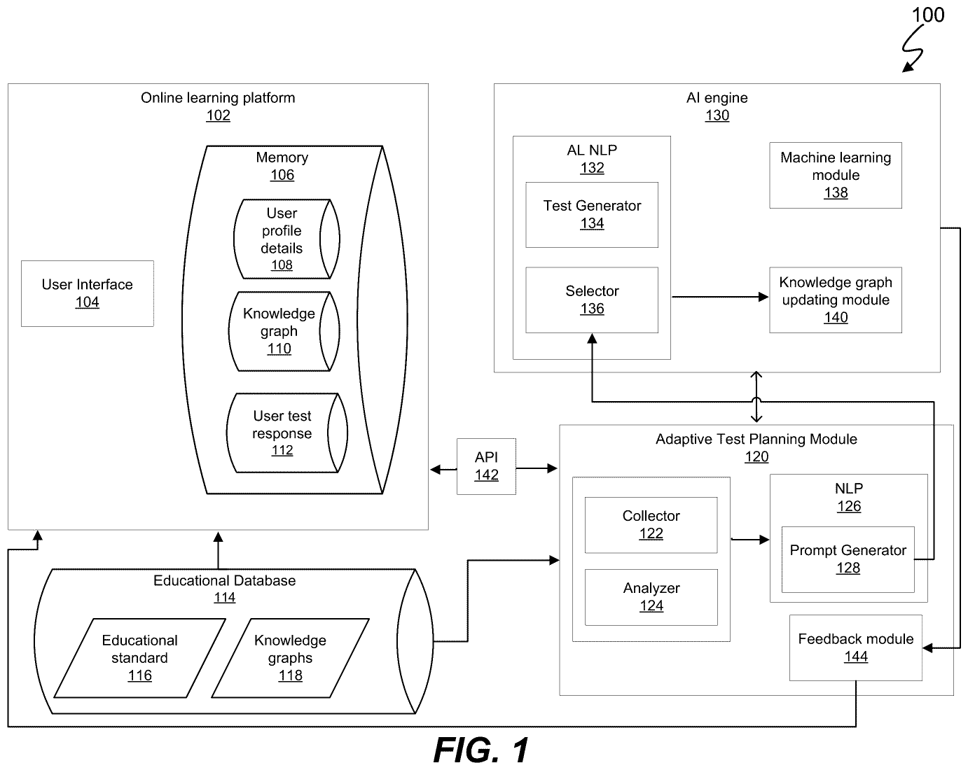

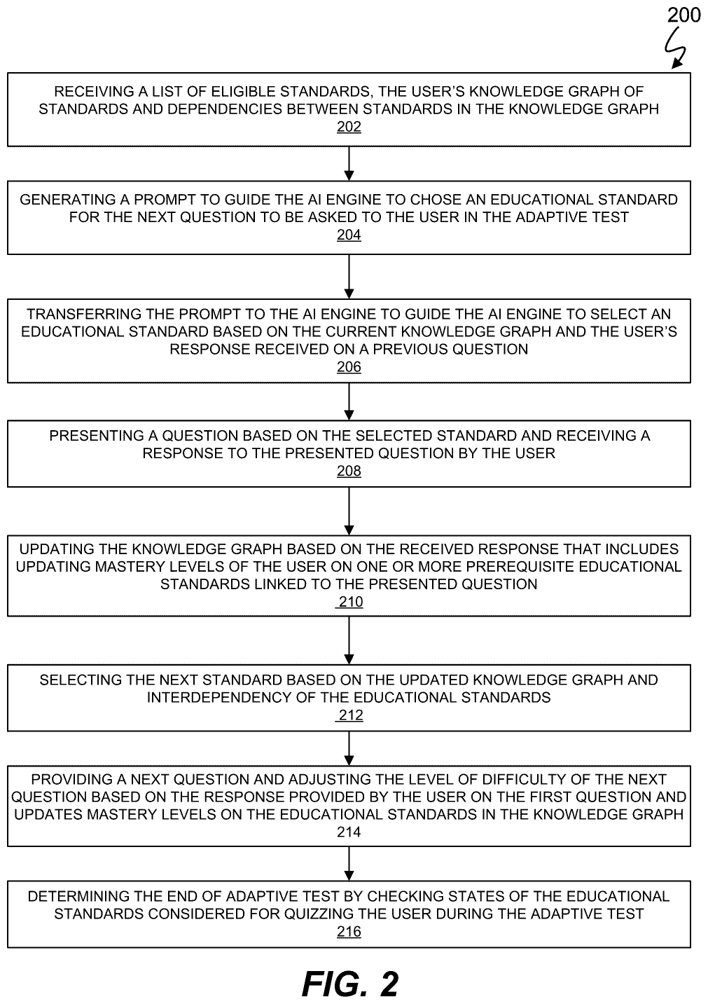

FIG. 1 depicts an exemplary adaptive test generation system 100 based on varying mastery levels of the user on educational standards 116. FIG. 2 depicts an exemplary upgrade process 200 based on varying mastery levels of the user on educational standards 116 utilized by the adaptive test generation system 100.

Referring to FIGS. 1 and 2, in operation 202, an adaptive test planning module 120 receives standards on which the user is eligible from the user's profile details 108, the user's knowledge graph 110, and dependencies between standards in the knowledge graph, the user's adaptive test response data 112, and additional data, that includes the time taken to answer the questions, correctness of the answers, session time of the adaptive test, and so on.

The details are collected using a collector 122 integrated within the adaptive test planning module 120. The current knowledge graph 110 indicates the mastery of educational standards 116 and the dependencies between the educational standards 116. The standards on which the user is eligible from the user's profile details 108, the user's knowledge graph 110, and dependencies between standards in the knowledge graph, the user's test response data 112, and additional data are stored in memory 106 of the online learning platform 102. The user test response data of the recent questions answered by the user are collected from the user's test response data 112 up to that point and stored in the online learning platform 102. The knowledge graph 118 and the educational standards dependencies are collected from an educational database 114.

The adaptive test planning module 120 is an important component of an online learning platform 102, designed to dynamically update a user's learning progress. The adaptive test planning module 120 operates in the backend and receives a variety of data inputs from memory 106 to ensure accurate and adaptive modifications to the user's current knowledge graph 110.

The data collection is facilitated by a collector 122 integrated within the adaptive test planning module 120. The current knowledge graph indicates the user's mastery over different educational standards 116 and shows the dependencies between these standards, forming a comprehensive map of the user's knowledge and learning path. All these details, the user's profile information 108, the user's current knowledge graph 110, the user's test response data 112, and additional performance metrics play a crucial role in helping the AI engine 130 to update the knowledge graph and generate the adaptive test. The test response data 112, which includes answers to recent questions, is continually updated and stored, ensuring that the most current information is available for processing.

The knowledge graph and the dependencies between educational standards 116 are sourced from an educational database 114, which provides a structured and reliable framework for evaluating and updating the user's learning progress. This educational database 114 acts as a repository for the standardized knowledge structure that the adaptive test generation system 100 uses to assess and adapt the user's learning path.

The adaptive test planning module 120 is closely integrated with the online learning platform 102, allowing it to seamlessly access and utilize the stored data. This integration enables real-time updates to the user's knowledge graph 110, ensuring that the learning experience is continually tailored to their evolving needs and performance.

The collector 122 integrated within the adaptive test planning module 120 is equipped with an analyzer 124 that plays a crucial role in the analysis of the collected data. This analyzer 124 is specifically configured to evaluate the correctness of the user's answers and to precisely record the time taken by the user to answer each question. By performing these assessments, the analyzer 124 provides detailed insights that are crucial for a prompt generator 128, which subsequently guides and constrains the AI engine 130 to select an educational standard for quizzing a user during an adaptive test and updating mastery levels of the user on educational standards 116 based on real-time responses to each question. By incorporating both accuracy and response time into its analysis, the analyzer 124 ensures that the adaptive test planning module 120 has a comprehensive understanding of the user's performance.

In operation 204, a prompt generator 128 utilizes NLP (Natural Language Processor) techniques to generate the prompt to guide and constrain the AI engine 130 to choose an educational standard for the next question to be asked to the user in the adaptive test. The prompt generator 128 receives the analyzed data from the analyzer 124 and makes use of that data to generate the prompt for the AI engine 130.

The prompt generator 128 is an essential component of the adaptive test planning module 120, employing Natural Language Processing (NLP) techniques to create precise and effective prompts. The prompt is designed to guide and constrain the AI engine 130 to select an educational standard 116 for quizzing a user during an adaptive test and updating mastery levels of the user on educational standard 116 based on real-time responses to each question. Initially, the analyzer 124 evaluates the user's answers, determining their correctness and recording the time taken for each response. This analyzed data is then sent to the prompt generator 128.

Using the insights provided by analyzer 124, prompt generator 128 utilizes advanced NLP techniques to interpret the data and generate clear, actionable prompts for the AI engine 130. For example, if the analyzer 124 indicates that a user is struggling with a particular educational standard, the prompt generator 128 will create a prompt that instructs the AI engine 130 to focus on that standard, perhaps by selecting additional related questions or providing supplementary learning materials. This seamless integration of data analysis and NLP 126 ensures that the AI engine 130 can effectively update the knowledge graph 110, thereby personalizing the learning experience to address the user's specific needs and promoting more efficient and targeted learning outcomes.

In operation 206, the prompt generator 128 transfers the prompts to the AI engine 130 to guide and constrain the AI engine 130 to select an educational standard based on the current knowledge graph and the user's response received on a previous question.

A prompt engineer creates a prompt structure along with the rules and guidelines to generate the prompts. This prompt structure is provided to the prompt generator 128 which utilizes the analyzed insights from the analyzer 124 and populates the prompt structure.

The prompt structure along with the rules and guidelines generated by the prompt engineer for selecting questions for a student to answer in an adaptive test is given below:

```
  Prompt Structure:
  ## Context
  You are an experienced educator who is selecting questions for
a student to answer in an adaptive placement test, with the aim of
getting a new student working on learning content that is at the
right level for them.
  ## Task
  You are being provided this as input:
  - A list of Eligible Standards which could be picked as the
Next Standard student should be quizzed on.
  - The student's knowledge graph of standards
    - The student's current knowledge is tracked in a knowledge
graph that has already been updated based on any previous questions
they've answered in the test.
    - The knowledge graph tracks the student's knowledge of each
educational standard as one of the following statuses:
      - LEARNED: Indicating that the student knows the standards
      - NOT_LEARNED: Indicating the student doesn't know the
standard
      - UNKNOWN: Indicating there is not enough information to
make a determination.
  - The dependencies between standards in the knowledge graph.
    - These are provided in the A => B, where A is prerequisite
to B which means,
      - If the student doesn't know A, then they don't know B as
well.
      - If the student knows B, then they know A as well.
      - Important: This relationship is transitive, but not
symmetric.
  - The latest questions that the student has answered on the
placement test, including the standard it's linked to and if it was
answered correctly or not.
      - This could be blank as well, when student is starting.
  Your task is to pick the next 5 standards that the student
should be quizzed on next, based on the above inputs.
      - These standards should be in ordered based on how we want
to them to be taken by the student. For ex: First standard in the
list should be first standard that we want to student to answer
question on.
  ## Example:
  Input:
  Eligible Standards List:
  ----------------------------
  Standard Status:
  ----------------------------
  id,grade,status
  Standard Dependencies:
  ----------------------------
  Latest Questions Answered:
  ----------------------------
  Output:
  Reasoning:
  ## Rules
  - Take a deep breath and work on this step by step.
  - It is mandatory to adhere to the specified output format for
compatibility with automated parsing systems.
    - The Next Standard section should always start with ‘Next
Standard:’.
    - The Reasoning section should always start with ‘Reasoning:’
  - Important: It is mandatory to pick the next standard from
the Eligible Standards list only, and it can't be from the Standard
Status list.
  - You should use a Multi-Step Adaptive Testing approach to
recalibrate the standard being asked quickly.
        - Instead of gradual (linear) adjustments, the algorithm
quickly recalibrates the standard based on each answer. For instance,
a correct answer could immediately lead to a significantly harder
question and an incorrect answer to an easier one. This approach aims
to find the student's level more quickly by making larger adjustments
in difficulty based on the student's performance.
  - Also, your goal should be to pick standards which enable the
student to finish the placement test as quickly as possible. Below
are the conditions that determine the completion of the placement
test.
      - When we find a standard that the student doesn't know,
and the student knows all its pre-requisites.
      - When we find a standard that the student doesn't know,
and it has no pre-requisites.
  - You should pick the next standard to quiz the student on
based on the state of the standards provided in the input
  - Double check the current status of each standard before
proceeding with the final decision.
  - Reminder: Failure to adhere to eligibility criteria of
picking a standard not in the eligible standard list may lead to
severe consequences.
  Now give me the next standard to quiz the student on, based on
the below input:
  Eligible Standards List:
  ----------------------------
  Standard Status:
  ----------------------------
  id,grade,status
  Standard Dependencies:
  ----------------------------
  standard 1 => standard 2
  Latest Questions Answered:
  ----------------------------
  standardId,correct
  Output:
  Next Standards:
  Reasoning:
```

The prompt generator 128 populates the prompt structure and transfers the prompts to the AI engine 130, providing specific instructions to guide and constrain the AI engine in selecting an educational standard. This selection is informed by the current knowledge graph, which maps the user's mastery levels and understanding of various educational standards, and the user's response to a previous question. By incorporating these elements, the AI engine 130 ensures that the chosen educational standard is in correspondence to the user's current knowledge state and learning needs, enabling a more personalized and effective adaptive testing experience.

In operation 208, a test generator 134, integrated within the AI engine 130 utilizes AI NLP to generate the adaptive test and present the adaptive test to the user on a user interface 104 integrated within the online learning platform 102. The AI engine 130 receives a response to the presented questions by the user.

The test generator 134 is integrated into the AI engine 130 and utilizes AI NLP (Artificial Intelligence Natural Language Processor) techniques using an AI NLP 132. The AI NLP 132 is integrated within the AI engine 130 and is operatively connected to the prompt generator 128 to receive the prompts. The prompt generator 128 transfers the prompts to the AI engine 130 to guide it in generating the adaptive test tailored to the user's current educational standard and knowledge graph 110.

Before presenting the adaptive test to the user, the selected educational standard undergoes a validation procedure to ensure its appropriateness. This involves applying a validation check to confirm that the chosen educational standard aligns with the user's current knowledge graph 110 and the dependencies between educational standards 116. If the validation check confirms the appropriateness of the selected educational standard, the adaptive test linked to this educational standard is provided to the user. If the check fails, the AI engine 130 is prompted to re-evaluate the selection criteria and choose an alternative educational standard 116 from the educational database 114.

The codes and functions mentioned in the pseudo-code of the adaptive test generation system 100 based on varying mastery levels of the user on educational standards 116 to select and validate the next standard are explained below in correspondence to the above mentioned details.

The Select Next Standard for Testing function, ‘select_next_standard_for_testing(knowledge_graph, standard_dependencies, question_history, testing_instructions)’, utilizes AI to determine the next standard a user should be quizzed on. It takes the user's current knowledge graph, the dependencies between standards, the history of questions asked, and specific testing instructions as inputs. Inside a loop, it invokes an AI engine 130 to predict the next standard. This predicted standard undergoes a validation check, and if it fails, the AI engine 130 is called again until a valid standard is selected. The function ensures the next standard chosen is appropriate and reliable.

To build confidence and ensure a positive initial experience, the AI engine 130 starts assessing users two grades below their current grade level. This approach helps to build a strong foundational understanding before progressing to more challenging educational content. The AI engine 130 maintains the difficulty level of the questions during the adaptive test based on the user's response patterns. This involves analyzing user responses, including correctness, response time, and, if available, confidence levels, to identify patterns. Questions are categorized into different difficulty levels based on predefined criteria, such as the complexity of the educational standard 116 and user performance data 112. The difficulty level of subsequent questions is then adjusted according to the user's responses, with easier questions being selected if the user is not performing well and harder questions if the user consistently performs well.

Further, the test generator 134 is designed to create a variety of question types to assess the user's knowledge. These question types include multiple-choice, short-answer, and interactive questions, providing a well-rounded evaluation of the user's understanding across different formats.

For example, a user struggling with basic algebra may first be given simpler arithmetic problems to build confidence. As they demonstrate proficiency, the test generator 134 gradually introduces more complex algebraic questions. The test generator 134 utilizes AI NLP to dynamically adjust the difficulty based on the user's performance, ensuring an appropriate level of challenge. Additionally, if the validation check deems that the selected algebra standard is too advanced, the AI engine 130 will re-evaluate and may select an introductory algebra standard instead. Throughout this process, the variety of question formats ensures that the user is tested comprehensively and engagingly, catering to different learning styles and abilities.

The prompt transferred to the AI engine 130 selects the educational standard to generate the adaptive test for the user is given below:

```
  Prompt:
  ## Context
  You are an experienced educator who is selecting questions for
a student to answer in an adaptive placement test, with the aim of
getting a new student working on learning content that is at the
right level for them.
  ## Task
  You are being provided this as input:
  - A list of Eligible Standards which could be picked as the
Next Standard student should be quizzed on.
  - The student's knowledge graph of standards
    - The student's current knowledge is tracked in a knowledge
graph that has already been updated based on any previous questions
they've answered in the test.
    - The knowledge graph tracks the student's knowledge of each
educational standard as one of the following statuses:
      - LEARNED: Indicating that the student knows the standards
      - NOT_LEARNED: Indicating the student doesn't know the
standard
      - UNKNOWN: Indicating there is not enough information to
make a determination.
  - The dependencies between standards in the knowledge graph.
    - These are provided in the A => B, where A is prerequisite
to B which means,
      - If the student doesn't know A, then they don't know B as
well.
      - If the student knows B, then they know A as well.
      - Important: This relationship is transitive, but not
symmetric.
  - The latest questions that the student has answered on the
placement test, including the standard it's linked to and if it was
answered correctly or not.
      - This could be blank as well, when student is starting.
  Your task is to pick the next 5 standards that the student
should be quizzed on next, based on the above inputs.
      - These standards should be in ordered based on how we want
to them to be taken by the student. For ex: First standard in the
list should be first standard that we want to student to answer
question on.
  ## Example:
  Input:
  Eligible Standards List:
  ----------------------------
  standard.f
  standard.g
  standard.h
  standard.i
  standard.j
  standard.k
  standard.l
  standard.o
  standard.p
  standard.q
  standard.r
  Standard Status:
  ----------------------------
  id,grade,status
  standard.a,4,LEARNED
  standard.b,4,LEARNED
  standard.c,4,NOT_LEARNED
  standard.d,4,LEARNED
  standard.e,4,LEARNED
  standard.f,4,UNKNOWN
  standard.g,4,UNKNOWN
  standard.h,4,UNKNOWN
  standard.i,4,UNKNOWN
  standard.j,4,UNKNOWN
  standard.k,4,UNKNOWN
  standard.l,4,UNKNOWN
  standard.m,4,NOT_LEARNED
  standard.n,4,NOT_LEARNED
  standard.o,4,UNKNOWN
  standard.p,4,UNKNOWN
  standard.q,4,UNKNOWN
  standard.r,4,UNKNOWN
  Standard Dependencies:
  ----------------------------
  standard 1 => standard 2
  standard.a => standard.b
  standard.d => standard.e
  standard.i => standard.c
  standard.e => standard.m
  standard.j => standard.n
  standard.g => standard.k
  standard.l => standard.j
  standard.o => standard.p
  standard.q => standard.r
  Latest Questions Answered:
  ----------------------------
  standardId,correct
  standard.n,0
  Output:
  Next Standard: standard.j
  Reasoning: Student just answered incorrectly on standard.n, now
checking its prerequisite.
  ## Rules
  - Take a deep breath and work on this step by step.
  - It is mandatory to adhere to the specified output format for
compatibility with automated parsing systems.
    - The Next Standard section should always start with ‘Next
Standard:’.
    - The Reasoning section should always start with ‘Reasoning:’
  - Important: It is mandatory to pick the next standard from
the Eligible Standards list only, and it can't be from the Standard
Status list.
  - You should use a Multi-Step Adaptive Testing approach to
recalibrate the standard being asked quickly.
        - Instead of gradual (linear) adjustments, the algorithm
quickly recalibrates the standard based on each answer. For instance,
a correct answer could immediately lead to a significantly harder
question and an incorrect answer to an easier one. This approach aims
to find the student's level more quickly by making larger adjustments
in difficulty based on the student's performance.
  - Also, your goal should be to pick standards which enable the
student to finish the placement test as quickly as possible. Below
are the conditions that determine the completion of the placement
test.
      - When we find a standard that the student doesn't know,
and the student knows all its pre-requisites.
      - When we find a standard that the student doesn't know,
and it has no pre-requisites.
  - You should pick the next standard to quiz the student on
based on the state of the standards provided in the input
  - Double check the current status of each standard before
proceeding with the final decision.
  - Reminder: Failure to adhere to eligibility criteria of
picking a standard not in the eligible standard list may lead to
severe consequences.
  Now give me the next standard to quiz the student on, based on
the below input:
  Eligible Standards List:
  ----------------------------
  CCSS.MATH.CONTENT.5.G.B.3
  CCSS.MATH.CONTENT.5.G.B.4
  CCSS.MATH.CONTENT.5.MD.A.1
  CCSS.MATH.CONTENT.5.MD.B.2
  CCSS.MATH.CONTENT.5.MD.C.3.A
  CCSS.MATH.CONTENT.5.MD.C.3.B
  CCSS.MATH.CONTENT.5.MD.C.4
  CCSS.MATH.CONTENT.5.MD.C.5.A
  CCSS.MATH.CONTENT.5.MD.C.5.B
  CCSS.MATH.CONTENT.5.MD.C.5.C
  CCSS.MATH.CONTENT.5.NBT.A.1
  CCSS.MATH.CONTENT.5.NBT.A.2
  CCSS.MATH.CONTENT.5.NBT.A.3.A
  CCSS.MATH.CONTENT.5.NBT.A.3.B
  CCSS.MATH.CONTENT.5.NBT.A.4
  CCSS.MATH.CONTENT.5.NBT.B.5
  CCSS.MATH.CONTENT.5.NBT.B.6
  CCSS.MATH.CONTENT.5.NBT.B.7
  CCSS.MATH.CONTENT.5.NF.A.1
  CCSS.MATH.CONTENT.5.NF.A.2
  CCSS.MATH.CONTENT.5.NF.B.3
  CCSS.MATH.CONTENT.5.NF.B.4.B
  CCSS.MATH.CONTENT.5.NF.B.5.A
  CCSS.MATH.CONTENT.5.NF.B.5.B
  CCSS.MATH.CONTENT.5.NF.B.6
  CCSS.MATH.CONTENT.5.NF.B.7.A
  CCSS.MATH.CONTENT.5.NF.B.7.B
  CCSS.MATH.CONTENT.5.NF.B.7.C
  CCSS.MATH.CONTENT.5.OA.A.1
  CCSS.MATH.CONTENT.5.OA.A.2
  CCSS.MATH.CONTENT.5.OA.B.3
  CCSS.MATH.CONTENT.6.EE.A.1
  CCSS.MATH.CONTENT.6.EE.A.2.A
  CCSS.MATH.CONTENT.6.EE.A.2.B
  CCSS.MATH.CONTENT.6.EE.A.2.C
  CCSS.MATH.CONTENT.6.EE.A.3
  CCSS.MATH.CONTENT.6.EE.A.4
  CCSS.MATH.CONTENT.6.EE.B.5
  CCSS.MATH.CONTENT.6.EE.B.6
  CCSS.MATH.CONTENT.6.EE.B.7
  CCSS.MATH.CONTENT.6.EE.B.8
  CCSS.MATH.CONTENT.6.EE.C.9
  CCSS.MATH.CONTENT.6.G.A.1
  CCSS.MATH.CONTENT.6.G.A.3
  CCSS.MATH.CONTENT.6.G.A.4
  CCSS.MATH.CONTENT.6.NS.A.1
  CCSS.MATH.CONTENT.6.NS.B.2
  CCSS.MATH.CONTENT.6.NS.B.3
  CCSS.MATH.CONTENT.6.NS.B.4
  CCSS.MATH.CONTENT.6.NS.C.5
  CCSS.MATH.CONTENT.6.NS.C.6.A
  CCSS.MATH.CONTENT.6.NS.C.6.B
  CCSS.MATH.CONTENT.6.NS.C.6.C
  CCSS.MATH.CONTENT.6.NS.C.7.A
  CCSS.MATH.CONTENT.6.NS.C.7.B
  CCSS.MATH.CONTENT.6.NS.C.7.C
  CCSS.MATH.CONTENT.6.NS.C.7.D
  CCSS.MATH.CONTENT.6.NS.C.8
  CCSS.MATH.CONTENT.6.RP.A.1
  CCSS.MATH.CONTENT.6.RP.A.2
  CCSS.MATH.CONTENT.6.RP.A.3.A
  CCSS.MATH.CONTENT.6.RP.A.3.B
  CCSS.MATH.CONTENT.6.RP.A.3.C
  CCSS.MATH.CONTENT.6.RP.A.3.D
  CCSS.MATH.CONTENT.6.SP.A.1
  CCSS.MATH.CONTENT.6.SP.A.2
  CCSS.MATH.CONTENT.6.SP.A.3
  CCSS.MATH.CONTENT.6.SP.B.4
  CCSS.MATH.CONTENT.6.SP.B.5.A
  CCSS.MATH.CONTENT.6.SP.B.5.B
  CCSS.MATH.CONTENT.6.SP.B.5.C
  CCSS.MATH.CONTENT.6.SP.B.5.D
  Standard Status:
  ----------------------------
  id,grade,status
  CCSS.MATH.CONTENT.5.G.A.1,5,LEARNED
  CCSS.MATH.CONTENT.5.G.A.2,5,LEARNED
  CCSS.MATH.CONTENT.5.G.B.3,5,UNKNOWN
  CCSS.MATH.CONTENT.5.G.B.4,5,UNKNOWN
  CCSS.MATH.CONTENT.5.MD.A.1,5,UNKNOWN
  CCSS.MATH.CONTENT.5.MD.B.2,5,UNKNOWN
  CCSS.MATH.CONTENT.5.MD.C.3.A,5,UNKNOWN
  CCSS.MATH.CONTENT.5.MD.C.3.B,5,UNKNOWN
  CCSS.MATH.CONTENT.5.MD.C.4,5,UNKNOWN
  CCSS.MATH.CONTENT.5.MD.C.5.A,5,UNKNOWN
  CCSS.MATH.CONTENT.5.MD.C.5.B,5,UNKNOWN
  CCSS.MATH.CONTENT.5.MD.C.5.C,5,UNKNOWN
  CCSS.MATH.CONTENT.5.NBT.A.1,5,UNKNOWN
  CCSS.MATH.CONTENT.5.NBT.A.2,5,UNKNOWN
  CCSS.MATH.CONTENT.5.NBT.A.3.A,5,UNKNOWN
  CCSS.MATH.CONTENT.5.NBT.A.3.B,5,UNKNOWN
  CCSS.MATH.CONTENT.5.NBT.A.4,5,UNKNOWN
  CCSS.MATH.CONTENT.5.NBT.B.5,5,UNKNOWN
  CCSS.MATH.CONTENT.5.NBT.B.6,5,UNKNOWN
  CCSS.MATH.CONTENT.5.NBT.B.7,5,UNKNOWN
  CCSS.MATH.CONTENT.5.NF.A.1,5,UNKNOWN
  CCSS.MATH.CONTENT.5.NF.A.2,5,UNKNOWN
  CCSS.MATH.CONTENT.5.NF.B.3,5,UNKNOWN
  CCSS.MATH.CONTENT.5.NF.B.4.A,5,LEARNED
  CCSS.MATH.CONTENT.5.NF.B.4.B,5,UNKNOWN
  CCSS.MATH.CONTENT.5.NF.B.5.A,5,UNKNOWN
  CCSS.MATH.CONTENT.5.NF.B.5.B,5,UNKNOWN
  CCSS.MATH.CONTENT.5.NF.B.6,5,UNKNOWN
  CCSS.MATH.CONTENT.5.NF.B.7.A,5,UNKNOWN
  CCSS.MATH.CONTENT.5.NF.B.7.B,5,UNKNOWN
  CCSS.MATH.CONTENT.5.NF.B.7.C,5,UNKNOWN
  CCSS.MATH.CONTENT.5.OA.A.1,5,UNKNOWN
  CCSS.MATH.CONTENT.5.OA.A.2,5,UNKNOWN
  CCSS.MATH.CONTENT.5.OA.B.3,5,UNKNOWN
  CCSS.MATH.CONTENT.6.EE.A.1,6,UNKNOWN
  CCSS.MATH.CONTENT.6.EE.A.2.A,6,UNKNOWN
  CCSS.MATH.CONTENT.6.EE.A.2.B,6,UNKNOWN
  CCSS.MATH.CONTENT.6.EE.A.2.C,6,UNKNOWN
  CCSS.MATH.CONTENT.6.EE.A.3,6,UNKNOWN
  CCSS.MATH.CONTENT.6.EE.A.4,6,UNKNOWN
  CCSS.MATH.CONTENT.6.EE.B.5,6,UNKNOWN
  CCSS.MATH.CONTENT.6.EE.B.6,6,UNKNOWN
  CCSS.MATH.CONTENT.6.EE.B.7,6,UNKNOWN
  CCSS.MATH.CONTENT.6.EE.B.8,6,UNKNOWN
  CCSS.MATH.CONTENT.6.EE.C.9,6,UNKNOWN
  CCSS.MATH.CONTENT.6.G.A.1,6,UNKNOWN
  CCSS.MATH.CONTENT.6.G.A.2,6,LEARNED
  CCSS.MATH.CONTENT.6.G.A.3,6,UNKNOWN
  CCSS.MATH.CONTENT.6.G.A.4,6,UNKNOWN
  CCSS.MATH.CONTENT.6.NS.A.1,6,UNKNOWN
  CCSS.MATH.CONTENT.6.NS.B.2,6,UNKNOWN
  CCSS.MATH.CONTENT.6.NS.B.3,6,UNKNOWN
  CCSS.MATH.CONTENT.6.NS.B.4,6,UNKNOWN
  CCSS.MATH.CONTENT.6.NS.C.5,6,UNKNOWN
  CCSS.MATH.CONTENT.6.NS.C.6.A,6,UNKNOWN
  CCSS.MATH.CONTENT.6.NS.C.6.B,6,UNKNOWN
  CCSS.MATH.CONTENT.6.NS.C.6.C,6,UNKNOWN
  CCSS.MATH.CONTENT.6.NS.C.7.A,6,UNKNOWN
  CCSS.MATH.CONTENT.6.NS.C.7.B,6,UNKNOWN
  CCSS.MATH.CONTENT.6.NS.C.7.C,6,UNKNOWN
  CCSS.MATH.CONTENT.6.NS.C.7.D,6,UNKNOWN
  CCSS.MATH.CONTENT.6.NS.C.8,6,UNKNOWN
  CCSS.MATH.CONTENT.6.RP.A.1,6,UNKNOWN
  CCSS.MATH.CONTENT.6.RP.A.2,6,UNKNOWN
  CCSS.MATH.CONTENT.6.RP.A.3.A,6,UNKNOWN
  CCSS.MATH.CONTENT.6.RP.A.3.B,6,UNKNOWN
  CCSS.MATH.CONTENT.6.RP.A.3.C,6,UNKNOWN
  CCSS.MATH.CONTENT.6.RP.A.3.D,6,UNKNOWN
  CCSS.MATH.CONTENT.6.SP.A.1,6,UNKNOWN
  CCSS.MATH.CONTENT.6.SP.A.2,6,UNKNOWN
  CCSS.MATH.CONTENT.6.SP.A.3,6,UNKNOWN
  CCSS.MATH.CONTENT.6.SP.B.4,6,UNKNOWN
  CCSS.MATH.CONTENT.6.SP.B.5.A,6,UNKNOWN
  CCSS.MATH.CONTENT.6.SP.B.5.B,6,UNKNOWN
  CCSS.MATH.CONTENT.6.SP.B.5.C,6,UNKNOWN
  CCSS.MATH.CONTENT.6.SP.B.5.D,6,UNKNOWN
  Standard Dependencies:
  ----------------------------
  standard 1 => standard 2
  CCSS.MATH.CONTENT.5.G.A.1=>CCSS.MATH.CONTENT.5.G.A.2
  CCSS.MATH.CONTENT.5.G.A.1=>CCSS.MATH.CONTENT.6.NS.C.6.B
  CCSS.MATH.CONTENT.5.G.A.1=>CCSS.MATH.CONTENT.6.NS.C.6.C
  CCSS.MATH.CONTENT.5.G.A.2=>CCSS.MATH.CONTENT.6.NS.C.8
  CCSS.MATH.CONTENT.5.G.A.2=>CCSS.MATH.CONTENT.6.G.A.3
  CCSS.MATH.CONTENT.5.G.A.2=>CCSS.MATH.CONTENT.6.RP.A.3.A
  CCSS.MATH.CONTENT.5.G.B.3=>CCSS.MATH.CONTENT.5.G.B.4
  CCSS.MATH.CONTENT.5.MD.B.2=>CCSS.MATH.CONTENT.6.SP.A.1
  CCSS.MATH.CONTENT.5.MD.B.2=>CCSS.MATH.CONTENT.6.SP.A.2
  CCSS.MATH.CONTENT.5.MD.B.2=>CCSS.MATH.CONTENT.6.SP.B.4
  CCSS.MATH.CONTENT.5.MD.C.3.A=>CCSS.MATH.CONTENT.5.MD.C.4
  CCSS.MATH.CONTENT.5.MD.C.3.B=>CCSS.MATH.CONTENT.5.MD.C.4
  CCSS.MATH.CONTENT.5.MD.C.4=>CCSS.MATH.CONTENT.5.MD.C.5.A
  CCSS.MATH.CONTENT.5.MD.C.5.A=>CCSS.MATH.CONTENT.6.G.A.2
  CCSS.MATH.CONTENT.5.MD.C.5.A=>CCSS.MATH.CONTENT.5.MD.C.5.B
  CCSS.MATH.CONTENT.5.MD.C.5.B=>CCSS.MATH.CONTENT.6.G.A.2
  CCSS.MATH.CONTENT.5.MD.C.5.B=>CCSS.MATH.CONTENT.5.MD.C.5.C
  CCSS.MATH.CONTENT.5.NBT.A.1=>CCSS.MATH.CONTENT.5.NBT.A.4
  CCSS.MATH.CONTENT.5.NBT.A.1=>CCSS.MATH.CONTENT.5.NBT.B.5
  CCSS.MATH.CONTENT.5.NBT.A.1=>CCSS.MATH.CONTENT.5.NBT.B.6
  CCSS.MATH.CONTENT.5.NBT.A.1=>CCSS.MATH.CONTENT.5.NBT.B.7
  CCSS.MATH.CONTENT.5.NBT.A.1=>CCSS.MATH.CONTENT.5.NBT.A.2
  CCSS.MATH.CONTENT.5.NBT.A.2=>CCSS.MATH.CONTENT.6.EE.A.1
  CCSS.MATH.CONTENT.5.NBT.A.3.B=>CCSS.MATH.CONTENT.5.NBT.A.4
  CCSS.MATH.CONTENT.5.NBT.B.5=>CCSS.MATH.CONTENT.5.NBT.B.6
  CCSS.MATH.CONTENT.5.NBT.B.5=>CCSS.MATH.CONTENT.6.NS.B.3
  CCSS.MATH.CONTENT.5.NBT.B.6=>CCSS.MATH.CONTENT.6.NS.B.3
  CCSS.MATH.CONTENT.5.NBT.B.6=>CCSS.MATH.CONTENT.6.NS.B.2
  CCSS.MATH.CONTENT.5.NBT.B.7=>CCSS.MATH.CONTENT.5.MD.A.1
  CCSS.MATH.CONTENT.5.NBT.B.7=>CCSS.MATH.CONTENT.6.NS.B.3
  CCSS.MATH.CONTENT.5.NF.A.1=>CCSS.MATH.CONTENT.5.NBT.B.7
  CCSS.MATH.CONTENT.5.NF.A.1=>CCSS.MATH.CONTENT.5.NF.A.2
  CCSS.MATH.CONTENT.5.NF.A.1=>CCSS.MATH.CONTENT.6.EE.B.7
  CCSS.MATH.CONTENT.5.NF.A.2=>CCSS.MATH.CONTENT.5.MD.B.2
  CCSS.MATH.CONTENT.5.NF.B.3=>CCSS.MATH.CONTENT.6.RP.A.2
  CCSS.MATH.CONTENT.5.NF.B.4.A=>CCSS.MATH.CONTENT.5.NF.B.5.B
  CCSS.MATH.CONTENT.5.NF.B.4.A=>CCSS.MATH.CONTENT.5.NF.B.5.A
  CCSS.MATH.CONTENT.5.NF.B.4.B=>CCSS.MATH.CONTENT.6.G.A.1
  CCSS.MATH.CONTENT.5.NF.B.5.A=>CCSS.MATH.CONTENT.6.RP.A.1
  CCSS.MATH.CONTENT.5.NF.B.6=>CCSS.MATH.CONTENT.5.MD.B.2
  CCSS.MATH.CONTENT.5.NF.B.7.A=>CCSS.MATH.CONTENT.6.NS.A.1
  CCSS.MATH.CONTENT.5.NF.B.7.B=>CCSS.MATH.CONTENT.6.NS.A.1
  CCSS.MATH.CONTENT.5.NF.B.7.C=>CCSS.MATH.CONTENT.6.NS.A.1
  CCSS.MATH.CONTENT.5.NF.B.7.C=>CCSS.MATH.CONTENT.5.MD.B.2
  CCSS.MATH.CONTENT.5.OA.A.1=>CCSS.MATH.CONTENT.5.OA.A.2
  CCSS.MATH.CONTENT.5.OA.A.2=>CCSS.MATH.CONTENT.6.NS.B.4
  CCSS.MATH.CONTENT.5.OA.A.2=>CCSS.MATH.CONTENT.6.EE.A.3
  CCSS.MATH.CONTENT.5.OA.A.2=>CCSS.MATH.CONTENT.6.EE.A.4
  CCSS.MATH.CONTENT.5.OA.A.2=>CCSS.MATH.CONTENT.6.EE.A.2.A
  CCSS.MATH.CONTENT.5.OA.A.2=>CCSS.MATH.CONTENT.6.EE.A.2.B
  CCSS.MATH.CONTENT.5.OA.B.3=>CCSS.MATH.CONTENT.6.RP.A.1
  CCSS.MATH.CONTENT.5.OA.B.3=>CCSS.MATH.CONTENT.6.EE.C.9
  CCSS.MATH.CONTENT.6.EE.A.1=>CCSS.MATH.CONTENT.6.EE.A.2.A
  CCSS.MATH.CONTENT.6.EE.A.1=>CCSS.MATH.CONTENT.6.EE.A.2.B
  CCSS.MATH.CONTENT.6.EE.A.1=>CCSS.MATH.CONTENT.6.EE.A.2.C
  CCSS.MATH.CONTENT.6.EE.A.2.A=>CCSS.MATH.CONTENT.6.EE.A.3
  CCSS.MATH.CONTENT.6.EE.A.2.A=>CCSS.MATH.CONTENT.6.EE.B.6
  CCSS.MATH.CONTENT.6.EE.A.2.C=>CCSS.MATH.CONTENT.6.EE.A.4
  CCSS.MATH.CONTENT.6.EE.A.2.C=>CCSS.MATH.CONTENT.6.EE.B.6
  CCSS.MATH.CONTENT.6.EE.A.2.C=>CCSS.MATH.CONTENT.6.EE.B.5
  CCSS.MATH.CONTENT.6.G.A.1=>CCSS.MATH.CONTENT.6.G.A.4
  CCSS.MATH.CONTENT.6.NS.A.1=>CCSS.MATH.CONTENT.6.EE.B.7
  CCSS.MATH.CONTENT.6.NS.B.2=>CCSS.MATH.CONTENT.6.NS.B.3
  CCSS.MATH.CONTENT.6.NS.B.4=>CCSS.MATH.CONTENT.6.EE.A.3
  CCSS.MATH.CONTENT.6.NS.B.4=>CCSS.MATH.CONTENT.6.EE.A.4
  CCSS.MATH.CONTENT.6.NS.C.5=>CCSS.MATH.CONTENT.6.NS.C.6.A
  CCSS.MATH.CONTENT.6.NS.C.6.A=>CCSS.MATH.CONTENT.6.NS.C.6.B
  CCSS.MATH.CONTENT.6.NS.C.6.A=>CCSS.MATH.CONTENT.6.NS.C.6.C
  CCSS.MATH.CONTENT.6.NS.C.6.A=>CCSS.MATH.CONTENT.6.NS.C.5
  CCSS.MATH.CONTENT.6.NS.C.6.A=>CCSS.MATH.CONTENT.6.EE.B.8
  CCSS.MATH.CONTENT.6.NS.C.6.A=>CCSS.MATH.CONTENT.6.NS.C.7.C
  CCSS.MATH.CONTENT.6.NS.C.6.B=>CCSS.MATH.CONTENT.6.NS.C.8
  CCSS.MATH.CONTENT.6.NS.C.6.C=>CCSS.MATH.CONTENT.6.EE.B.8
  CCSS.MATH.CONTENT.6.NS.C.6.C=>CCSS.MATH.CONTENT.6.NS.C.7.A
  CCSS.MATH.CONTENT.6.NS.C.6.C=>CCSS.MATH.CONTENT.6.NS.C.7.B
  CCSS.MATH.CONTENT.6.NS.C.7.A=>CCSS.MATH.CONTENT.6.EE.B.8
  CCSS.MATH.CONTENT.6.NS.C.7.A=>CCSS.MATH.CONTENT.6.NS.C.7.D
  CCSS.MATH.CONTENT.6.NS.C.7.B=>CCSS.MATH.CONTENT.6.EE.B.8
  CCSS.MATH.CONTENT.6.NS.C.7.B=>CCSS.MATH.CONTENT.6.NS.C.7.D
  CCSS.MATH.CONTENT.6.NS.C.7.C=>CCSS.MATH.CONTENT.6.NS.C.7.D
  CCSS.MATH.CONTENT.6.RP.A.1=>CCSS.MATH.CONTENT.6.RP.A.2
  CCSS.MATH.CONTENT.6.RP.A.1=>CCSS.MATH.CONTENT.6.RP.A.3.A
  CCSS.MATH.CONTENT.6.RP.A.2=>CCSS.MATH.CONTENT.6.RP.A.3.B
  CCSS.MATH.CONTENT.6.RP.A.2=>CCSS.MATH.CONTENT.6.RP.A.3.C
  CCSS.MATH.CONTENT.6.RP.A.2=>CCSS.MATH.CONTENT.6.RP.A.3.D
  CCSS.MATH.CONTENT.6.RP.A.3.A=>CCSS.MATH.CONTENT.6.RP.A.3.B
  CCSS.MATH.CONTENT.6.SP.A.1=>CCSS.MATH.CONTENT.6.SP.A.3
  CCSS.MATH.CONTENT.6.SP.A.2=>CCSS.MATH.CONTENT.6.SP.A.3
  CCSS.MATH.CONTENT.6.SP.A.2=>CCSS.MATH.CONTENT.6.SP.B.5.A
  CCSS.MATH.CONTENT.6.SP.A.2=>CCSS.MATH.CONTENT.6.SP.B.5.B
  CCSS.MATH.CONTENT.6.SP.A.2=>CCSS.MATH.CONTENT.6.SP.B.5.C
  CCSS.MATH.CONTENT.6.SP.A.2=>CCSS.MATH.CONTENT.6.SP.B.5.D
  CCSS.MATH.CONTENT.6.SP.A.3=>CCSS.MATH.CONTENT.6.SP.B.5.A
  CCSS.MATH.CONTENT.6.SP.A.3=>CCSS.MATH.CONTENT.6.SP.B.5.B
  CCSS.MATH.CONTENT.6.SP.A.3=>CCSS.MATH.CONTENT.6.SP.B.5.C
  CCSS.MATH.CONTENT.6.SP.A.3=>CCSS.MATH.CONTENT.6.SP.B.5.D
  Latest Questions Answered:
  ----------------------------
  standardId,correct
  CCSS.MATH.CONTENT.5.G.A.2,1
  Output:
  Next Standards: CCSS.MATH.CONTENT.6.NS.C.8
  Reasoning: This standard is linked to
CCSS.MATH.CONTENT.5.G.A.2, which the student has just correctly
answered. It will help quickly ascertain the student's understanding
at a higher level.
```

The prompt generated by the prompt generator 128 in the above code involves a mathematical task or problem that shows the user's recent success in geometry (CCSS.MATH.CONTENT.5.G.A.2) with the higher-level understanding required in number systems (CCSS.MATH.CONTENT.6.NS.C.8). It could pose a scenario that challenges the user to apply their geometric knowledge in a context that requires understanding of number systems, such as calculating distances or angles using numerical operations. This prompt aims to assess the user's ability to transfer skills across related mathematical domains, encouraging deeper comprehension and application of mathematical concepts beyond isolated standards.

The input provided to the prompt generator 128 comprises specific details related to educational standards 116 and the user's recent test data. It includes information such as the details of the educational standard 116, for instance, CCSS.MATH.CONTENT.6.NS.C.8, which denotes a particular mathematical concept or skill level expected at a sixth-grade level. Additionally, the input highlights the user's recent correct answer to CCSS.MATH.CONTENT.5.G.A.2, indicating their proficiency in foundational geometry concepts.

This input data serves as the basis for generating prompts that are aligned with the user's demonstrated skills and knowledge progression. By utilizing the connection between different educational standards 116, the AI engine 130 aims to support the user's learning experience, moving them towards more advanced concepts while ensuring they are adequately challenged and supported in their educational journey. The input thus enables the prompt generator 128 to offer relevant and engaging tasks that provide continuous learning and mastery of the subject matter.

The response provided by the prompt includes the next educational standard, CCSS.MATH.CONTENT.6.NS.C.8 has been selected based on the user's recent correct answer to CCSS.MATH.CONTENT.5.G.A.2. This choice is guided by the selector's 136 recognition of the relationship between these educational standards 116, where CCSS.MATH.CONTENT.6.NS.C.8 builds upon the foundational concepts covered in CCSS.MATH.CONTENT.5.G.A.2. By progressing to CCSS.MATH.CONTENT.6.NS.C.8, the AI engine 130 aims to efficiently assess the user's comprehension at a more advanced level, utilizing their demonstrated ability to grasp related material. This adaptive approach not only encourages continuous learning but also ensures that the user is appropriately challenged, thereby promoting a deeper understanding and mastery of mathematical concepts across the curriculum.

In operation 210, a knowledge graph updating module 140 updates the knowledge graph based on the received response including updating mastery levels of the user on one or more pre-requisite educational standards 116 linked to the presented question.

The updation of the user's current knowledge graph 110 using a knowledge graph updater 140 ensures that the educational content is in correspondence with the user's learning needs and progress. Initially, the response received from the user is evaluated based on the presented questions and integrating the correctness of the user's responses during the adaptive test into the knowledge graph. Each correct or incorrect response is mapped to indicate whether the user has mastered the educational standard assessed by the question. For instance, if a user correctly answers questions related to a specific math concept, the knowledge graph will reflect this mastery, while incorrect answers will highlight areas needing improvement.

Next, the relationships and dependencies between educational standards 116 within the knowledge graph 118 are updated based on the user's responses. This update reflects changes in the user's mastery level. For example, if mastering a fundamental concept is a prerequisite for more advanced topics, the knowledge graph will adjust to show the user's readiness to tackle these advanced topics based on their test performance.

The codes and functions mentioned in the pseudo-code of the adaptive test generation system 100 based on varying mastery levels of the user on educational standards 116 to update the knowledge graph are explained below in correspondence to the above mentioned details.

The Update Knowledge Graph function, ‘update_knowledge_graph(knowledge_graph, standard_dependencies, question_response)’, updates the user's knowledge graph based on their response to a question. It uses the knowledge graph upgradation module 140 to determine the necessary changes to the knowledge graph, considering the correctness of the user's response and the dependencies between standards. The function then applies these changes to the knowledge graph, reflecting the user's updated understanding of the related standards.

Additionally, the knowledge graph updater 140 is configured to incorporate changes in the standard dependencies based on the user's performance in the adaptive test. This ensures that the knowledge graph accurately reflects the user's current mastery and learning progress. For example, if a user's performance indicates they have mastered a foundational concept earlier than expected, the graph will be updated to show this, allowing the user to progress to more advanced topics sooner.

The knowledge graph is further adjusted based on the most recent question responses, ensuring it accurately represents the user's current knowledge state. This real-time adjustment is crucial for maintaining an up-to-date and precise depiction of the user's learning journey. The AI engine 130 plays a pivotal role in determining whether to continue or end the adaptive test based on the updated knowledge graph, standard dependencies, and the user's response to the most recent question. If the knowledge graph indicates that the user has sufficiently mastered the required standards, the test may end. Otherwise, it may continue, adapting to the user's needs.

The codes and functions mentioned in the pseudo-code of the adaptive test generation system 100 based on varying mastery levels of the user on educational standards 116 to determine the end of the adaptive test are explained below in correspondence to the above mentioned details:
The Determine End of Adaptive Testing function, ‘determine_end_of_placement(knowledge_graph, standard_dependencies, conditions_to_end_testing)’, decides if the adaptive testing should conclude. It evaluates the user's knowledge graph, the dependencies between standards, and the predefined conditions for ending the test. By invoking the AI engine 130, the function checks if the criteria for concluding the placement testing have been met, ensuring the testing process ends at an appropriate time based on the user's performance.

The exemplary prompt generated by the prompt generator 128 that guides and constrains the AI engine 130 to update the knowledge graph, along with the output and the reason behind the generation of that output is given below wherein CCSS stands for Common Core State Standards:

```
  Prompt:
  ## Context
  You are an experienced tutor tasked with updating a student's
knowledge graph, based on questions they're answering in an adaptive
placement test.
  ## Task
  You are being provided as input:
  - The student's knowledge graph of standards
    - The student's current knowledge is tracked in a knowledge
graph that has already been updated based on any questions they've
answered in the test.
    - The knowledge graph tracks the student's knowledge of each
educational standard as one of the following statuses:
      - LEARNED: Indicating that the student knows the standards
      - NOT_LEARNED: Indicating the student doesn't know the
standard
      - UNKNOWN: Indicating there is not enough information to
make a determination.
  - The dependencies between standards in the knowledge graph.
    - These are provided in the A => B, where A is prerequisite
to B which means,
      - If the student doesn't know A, then they don't know B as
well.
      - If the student knows B, then they know A as well.
      - Important: This relationship is transitive, but not
symmetric.
  - The latest questions that the student has answered on the
placement test, including the standard it's linked to and if it was
answered correctly or not.
      - This could be blank as well, when student is starting.
  Your task is to update the status of standards based on student
responses and dependencies.
  ## Example:
  Input:
  Standard Status:
  ----------------------------
  id,grade,status
  standard.a,4,LEARNED
  standard.b,4,LEARNED
  standard.c,4,NOT_LEARNED
  standard.d,4,LEARNED
  standard.e,4,LEARNED
  standard.f,4,UNKNOWN
  standard.g,4,UNKNOWN
  standard.h,4,UNKNOWN
  standard.i,4,UNKNOWN
  standard.j,4,UNKNOWN
  standard.k,4,UNKNOWN
  standard.l,4,UNKNOWN
  standard.m,4,NOT_LEARNED
  standard.n,4,UNKNOWN
  standard.0,4,UNKNOWN
  standard.p,4,UNKNOWN
  standard.q,4,UNKNOWN
  standard.r,4,UNKNOWN
  Standard Dependencies:
  ----------------------------
  standard 1 => standard 2
  standard.a => standard.b
  standard.d => standard.e
  standard.i => standard.c
  standard.e => standard.m
  standard.j => standard.n
  standard.g => standard.k
  standard.l => standard.j
  standard.o => standard.p
  standard.q => standard.r
  New Questions Answered:
  ----------------------------
  standardId,correct
  standard.j,0
  Output:
  standard.j,NOT_LEARNED
  standard.n,NOT_LEARNED
  Reasoning: Incorrect response on standard.j means student
doesn't know the standard and any of the dependent standards.
  ## Rules
  - Take a deep breath and work on this step by step.
  - It is mandatory to adhere to the specified output format for
compatibility with automated parsing systems.
    - List of standards that needs status update should simply
list StandardID,New Status as shown in Output Example.
    - The Reasoning should always start with ‘Reasoning:’
  - Important: Below are the conditions when we should update the
standard status.
      - If student answered a question correctly, then change the
state of the standard to be LEARNED. Additionally, change the status
for all the prerequisite standards on this LEARNED standard also as
LEARNED.
      - If student answered a question incorrectly, then change
the state of the standard to be NOT_LEARNED. Additionally, change the
status for all the dependent standards on this NOT_LEARNED standard
also as NOT_LEARNED.
  - Include reasoning for output decision to justify the proposed
decision.
  Now based on below input, determine the status change for the
standards:
  Standard Status:
  ----------------------------
  id,grade,status
  CCSS.MATH.CONTENT.5.G.A.1,5,LEARNED
  CCSS.MATH.CONTENT.5.G.A.2,5,LEARNED
  CCSS.MATH.CONTENT.5.G.B.3,5,UNKNOWN
  CCSS.MATH.CONTENT.5.G.B.4,5,UNKNOWN
  CCSS.MATH.CONTENT.5.MD.A.1,5,UNKNOWN
  CCSS.MATH.CONTENT.5.MD.B.2,5,UNKNOWN
  CCSS.MATH.CONTENT.5.MD.C.3.A,5,UNKNOWN
  CCSS.MATH.CONTENT.5.MD.C.3.B,5,UNKNOWN
  CCSS.MATH.CONTENT.5.MD.C.4,5,UNKNOWN
  CCSS.MATH.CONTENT.5.MD.C.5.A,5,UNKNOWN
  CCSS.MATH.CONTENT.5.MD.C.5.B,5,UNKNOWN
  CCSS.MATH.CONTENT.5.MD.C.5.C,5,UNKNOWN
  CCSS.MATH.CONTENT.5.NBT.A.1,5,UNKNOWN
  CCSS.MATH.CONTENT.5.NBT.A.2,5,UNKNOWN
  CCSS.MATH.CONTENT.5.NBT.A.3.A,5,UNKNOWN
  CCSS.MATH.CONTENT.5.NBT.A.3.B,5,UNKNOWN
  CCSS.MATH.CONTENT.5.NBT.A.4,5,UNKNOWN
  CCSS.MATH.CONTENT.5.NBT.B.5,5,UNKNOWN
  CCSS.MATH.CONTENT.5.NBT.B.6,5,UNKNOWN
  CCSS.MATH.CONTENT.5.NBT.B.7,5,UNKNOWN
  CCSS.MATH.CONTENT.5.NF.A.1,5,UNKNOWN
  CCSS.MATH.CONTENT.5.NF.A.2,5,UNKNOWN
  CCSS.MATH.CONTENT.5.NF.B.3,5,UNKNOWN
  CCSS.MATH.CONTENT.5.NF.B.4.A,5,LEARNED
  CCSS.MATH.CONTENT.5.NF.B.4.B,5,UNKNOWN
  CCSS.MATH.CONTENT.5.NF.B.5.A,5,UNKNOWN
  CCSS.MATH.CONTENT.5.NF.B.5.B,5,UNKNOWN
  CCSS.MATH.CONTENT.5.NF.B.6,5,UNKNOWN
  CCSS.MATH.CONTENT.5.NF.B.7.A,5,UNKNOWN
  CCSS.MATH.CONTENT.5.NF.B.7.B,5,UNKNOWN
  CCSS.MATH.CONTENT.5.NF.B.7.C,5,UNKNOWN
  CCSS.MATH.CONTENT.5.OA.A.1,5,UNKNOWN
  CCSS.MATH.CONTENT.5.OA.A.2,5,UNKNOWN
  CCSS.MATH.CONTENT.5.OA.B.3,5,UNKNOWN
  CCSS.MATH.CONTENT.6.EE.A.1,6,UNKNOWN
  CCSS.MATH.CONTENT.6.EE.A.2.A,6,UNKNOWN
  CCSS.MATH.CONTENT.6.EE.A.2.B,6,UNKNOWN
  CCSS.MATH.CONTENT.6.EE.A.2.C,6,UNKNOWN
  CCSS.MATH.CONTENT.6.EE.A.3,6,UNKNOWN
  CCSS.MATH.CONTENT.6.EE.A.4,6,UNKNOWN
  CCSS.MATH.CONTENT.6.EE.B.5,6,UNKNOWN
  CCSS.MATH.CONTENT.6.EE.B.6,6,UNKNOWN
  CCSS.MATH.CONTENT.6.EE.B.7,6,UNKNOWN
  CCSS.MATH.CONTENT.6.EE.B.8,6,UNKNOWN
  CCSS.MATH.CONTENT.6.EE.C.9,6,UNKNOWN
  CCSS.MATH.CONTENT.6.G.A.1,6,UNKNOWN
  CCSS.MATH.CONTENT.6.G.A.2,6,LEARNED
  CCSS.MATH.CONTENT.6.G.A.3,6,UNKNOWN
  CCSS.MATH.CONTENT.6.G.A.4,6,UNKNOWN
  CCSS.MATH.CONTENT.6.NS.A.1,6,UNKNOWN
  CCSS.MATH.CONTENT.6.NS.B.2,6,UNKNOWN
  CCSS.MATH.CONTENT.6.NS.B.3,6,UNKNOWN
  CCSS.MATH.CONTENT.6.NS.B.4,6,UNKNOWN
  CCSS.MATH.CONTENT.6.NS.C.5,6,UNKNOWN
  CCSS.MATH.CONTENT.6.NS.C.6.A,6,UNKNOWN
  CCSS.MATH.CONTENT.6.NS.C.6.B,6,UNKNOWN
  CCSS.MATH.CONTENT.6.NS.C.6.C,6,UNKNOWN
  CCSS.MATH.CONTENT.6.NS.C.7.A,6,UNKNOWN
  CCSS.MATH.CONTENT.6.NS.C.7.B,6,UNKNOWN
  CCSS.MATH.CONTENT.6.NS.C.7.C,6,UNKNOWN
  CCSS.MATH.CONTENT.6.NS.C.7.D,6,UNKNOWN
  CCSS.MATH.CONTENT.6.NS.C.8,6,UNKNOWN
  CCSS.MATH.CONTENT.6.RP.A.1,6,UNKNOWN
  CCSS.MATH.CONTENT.6.RP.A.2,6,UNKNOWN
  CCSS.MATH.CONTENT.6.RP.A.3.A,6,UNKNOWN
  CCSS.MATH.CONTENT.6.RP.A.3.B,6,UNKNOWN
  CCSS.MATH.CONTENT.6.RP.A.3.C,6,UNKNOWN
  CCSS.MATH.CONTENT.6.RP.A.3.D,6,UNKNOWN
  CCSS.MATH.CONTENT.6.SP.A.1,6,UNKNOWN
  CCSS.MATH.CONTENT.6.SP.A.2,6,UNKNOWN
  CCSS.MATH.CONTENT.6.SP.A.3,6,UNKNOWN
  CCSS.MATH.CONTENT.6.SP.B.4,6,UNKNOWN
  CCSS.MATH.CONTENT.6.SP.B.5.A,6,UNKNOWN
  CCSS.MATH.CONTENT.6.SP.B.5.B,6,UNKNOWN
  CCSS.MATH.CONTENT.6.SP.B.5.C,6,UNKNOWN
  CCSS.MATH.CONTENT.6.SP.B.5.D,6,UNKNOWN
  Standard Dependencies:
  ----------------------------
  standard 1 => standard 2
  CCSS.MATH.CONTENT.5.G.A.1=>CCSS.MATH.CONTENT.5.G.A.2
  CCSS.MATH.CONTENT.5.G.A.1=>CCSS.MATH.CONTENT.6.NS.C.6.B
  CCSS.MATH.CONTENT.5.G.A.1=>CCSS.MATH.CONTENT.6.NS.C.6.C
  CCSS.MATH.CONTENT.5.G.A.2=>CCSS.MATH.CONTENT.6.NS.C.8
  CCSS.MATH.CONTENT.5.G.A.2=>CCSS.MATH.CONTENT.6.G.A.3
  CCSS.MATH.CONTENT.5.G.A.2=>CCSS.MATH.CONTENT.6.RP.A.3.A
  CCSS.MATH.CONTENT.5.G.B.3=>CCSS.MATH.CONTENT.5.G.B.4
  CCSS.MATH.CONTENT.5.MD.B.2=>CCSS.MATH.CONTENT.6.SP.A.1
  CCSS.MATH.CONTENT.5.MD.B.2=>CCSS.MATH.CONTENT.6.SP.A.2
  CCSS.MATH.CONTENT.5.MD.B.2=>CCSS.MATH.CONTENT.6.SP.B.4
  CCSS.MATH.CONTENT.5.MD.C.3.A=>CCSS.MATH.CONTENT.5.MD.C.4
  CCSS.MATH.CONTENT.5.MD.C.3.B=>CCSS.MATH.CONTENT.5.MD.C.4
  CCSS.MATH.CONTENT.5.MD.C.4=>CCSS.MATH.CONTENT.5.MD.C.5.A
  CCSS.MATH.CONTENT.5.MD.C.5.A=>CCSS.MATH.CONTENT.6.G.A.2
  CCSS.MATH.CONTENT.5.MD.C.5.A=>CCSS.MATH.CONTENT.5.MD.C.5.B
  CCSS.MATH.CONTENT.5.MD.C.5.B=>CCSS.MATH.CONTENT.6.G.A.2
  CCSS.MATH.CONTENT.5.MD.C.5.B=>CCSS.MATH.CONTENT.5.MD.C.5.C
  CCSS.MATH.CONTENT.5.NBT.A.1=>CCSS.MATH.CONTENT.5.NBT.A.4
  CCSS.MATH.CONTENT.5.NBT.A.1=>CCSS.MATH.CONTENT.5.NBT.B.5
  CCSS.MATH.CONTENT.5.NBT.A.1=>CCSS.MATH.CONTENT.5.NBT.B.6
  CCSS.MATH.CONTENT.5.NBT.A.1=>CCSS.MATH.CONTENT.5.NBT.B.7
  CCSS.MATH.CONTENT.5.NBT.A.1=>CCSS.MATH.CONTENT.5.NBT.A.2
  CCSS.MATH.CONTENT.5.NBT.A.2=>CCSS.MATH.CONTENT.6.EE.A.1
  CCSS.MATH.CONTENT.5.NBT.A.3.B=>CCSS.MATH.CONTENT.5.NBT.A.4
  CCSS.MATH.CONTENT.5.NBT.B.5=>CCSS.MATH.CONTENT.5.NBT.B.6
  CCSS.MATH.CONTENT.5.NBT.B.5=>CCSS.MATH.CONTENT.6.NS.B.3
  CCSS.MATH.CONTENT.5.NBT.B.6=>CCSS.MATH.CONTENT.6.NS.B.3
  CCSS.MATH.CONTENT.5.NBT.B.6=>CCSS.MATH.CONTENT.6.NS.B.2
  CCSS.MATH.CONTENT.5.NBT.B.7=>CCSS.MATH.CONTENT.5.MD.A.1
  CCSS.MATH.CONTENT.5.NBT.B.7=>CCSS.MATH.CONTENT.6.NS.B.3
  CCSS.MATH.CONTENT.5.NF.A.1=>CCSS.MATH.CONTENT.5.NBT.B.7
  CCSS.MATH.CONTENT.5.NF.A.1=>CCSS.MATH.CONTENT.5.NF.A.2
  CCSS.MATH.CONTENT.5.NF.A.1=>CCSS.MATH.CONTENT.6.EE.B.7
  CCSS.MATH.CONTENT.5.NF.A.2=>CCSS.MATH.CONTENT.5.MD.B.2
  CCSS.MATH.CONTENT.5.NF.B.3=>CCSS.MATH.CONTENT.6.RP.A.2
  CCSS.MATH.CONTENT.5.NF.B.4.A=>CCSS.MATH.CONTENT.5.NF.B.5.B
  CCSS.MATH.CONTENT.5.NF.B.4.A=>CCSS.MATH.CONTENT.5.NF.B.5.A
  CCSS.MATH.CONTENT.5.NF.B.4.B=>CCSS.MATH.CONTENT.6.G.A.1
  CCSS.MATH.CONTENT.5.NF.B.5.A=>CCSS.MATH.CONTENT.6.RP.A.1
  CCSS.MATH.CONTENT.5.NF.B.6=>CCSS.MATH.CONTENT.5.MD.B.2
  CCSS.MATH.CONTENT.5.NF.B.7.A=>CCSS.MATH.CONTENT.6.NS.A.1
  CCSS.MATH.CONTENT.5.NF.B.7.B=>CCSS.MATH.CONTENT.6.NS.A.1
  CCSS.MATH.CONTENT.5.NF.B.7.C=>CCSS.MATH.CONTENT.6.NS.A.1
  CCSS.MATH.CONTENT.5.NF.B.7.C=>CCSS.MATH.CONTENT.5.MD.B.2
  CCSS.MATH.CONTENT.5.OA.A.1=>CCSS.MATH.CONTENT.5.OA.A.2
  CCSS.MATH.CONTENT.5.OA.A.2=>CCSS.MATH.CONTENT.6.NS.B.4
  CCSS.MATH.CONTENT.5.OA.A.2=>CCSS.MATH.CONTENT.6.EE.A.3
  CCSS.MATH.CONTENT.5.OA.A.2=>CCSS.MATH.CONTENT.6.EE.A.4
  CCSS.MATH.CONTENT.5.OA.A.2=>CCSS.MATH.CONTENT.6.EE.A.2.A
  CCSS.MATH.CONTENT.5.OA.A.2=>CCSS.MATH.CONTENT.6.EE.A.2.B
  CCSS.MATH.CONTENT.5.OA.B.3=>CCSS.MATH.CONTENT.6.RP.A.1
  CCSS.MATH.CONTENT.5.OA.B.3=>CCSS.MATH.CONTENT.6.EE.C.9
  CCSS.MATH.CONTENT.6.EE.A.1=>CCSS.MATH.CONTENT.6.EE.A.2.A
  CCSS.MATH.CONTENT.6.EE.A.1=>CCSS.MATH.CONTENT.6.EE.A.2.B
  CCSS.MATH.CONTENT.6.EE.A.1=>CCSS.MATH.CONTENT.6.EE.A.2.C
  CCSS.MATH.CONTENT.6.EE.A.2.A=>CCSS.MATH.CONTENT.6.EE.A.3
  CCSS.MATH.CONTENT.6.EE.A.2.A=>CCSS.MATH.CONTENT.6.EE.B.6
  CCSS.MATH.CONTENT.6.EE.A.2.C=>CCSS.MATH.CONTENT.6.EE.A.4
  CCSS.MATH.CONTENT.6.EE.A.2.C=>CCSS.MATH.CONTENT.6.EE.B.6
  CCSS.MATH.CONTENT.6.EE.A.2.C=>CCSS.MATH.CONTENT.6.EE.B.5
  CCSS.MATH.CONTENT.6.G.A.1=>CCSS.MATH.CONTENT.6.G.A.4
  CCSS.MATH.CONTENT.6.NS.A.1=>CCSS.MATH.CONTENT.6.EE.B.7
  CCSS.MATH.CONTENT.6.NS.B.2=>CCSS.MATH.CONTENT.6.NS.B.3
  CCSS.MATH.CONTENT.6.NS.B.4=>CCSS.MATH.CONTENT.6.EE.A.3
  CCSS.MATH.CONTENT.6.NS.B.4=>CCSS.MATH.CONTENT.6.EE.A.4
  CCSS.MATH.CONTENT.6.NS.C.5=>CCSS.MATH.CONTENT.6.NS.C.6.A
  CCSS.MATH.CONTENT.6.NS.C.6.A=>CCSS.MATH.CONTENT.6.NS.C.6.B
  CCSS.MATH.CONTENT.6.NS.C.6.A=>CCSS.MATH.CONTENT.6.NS.C.6.C
  CCSS.MATH.CONTENT.6.NS.C.6.A=>CCSS.MATH.CONTENT.6.NS.C.5
  CCSS.MATH.CONTENT.6.NS.C.6.A=>CCSS.MATH.CONTENT.6.EE.B.8
  CCSS.MATH.CONTENT.6.NS.C.6.A=>CCSS.MATH.CONTENT.6.NS.C.7.C
  CCSS.MATH.CONTENT.6.NS.C.6.B=>CCSS.MATH.CONTENT.6.NS.C.8
  CCSS.MATH.CONTENT.6.NS.C.6.C=>CCSS.MATH.CONTENT.6.EE.B.8
  CCSS.MATH.CONTENT.6.NS.C.6.C=>CCSS.MATH.CONTENT.6.NS.C.7.A
  CCSS.MATH.CONTENT.6.NS.C.6.C=>CCSS.MATH.CONTENT.6.NS.C.7.B
  CCSS.MATH.CONTENT.6.NS.C.7.A=>CCSS.MATH.CONTENT.6.EE.B.8
  CCSS.MATH.CONTENT.6.NS.C.7.A=>CCSS.MATH.CONTENT.6.NS.C.7.D
  CCSS.MATH.CONTENT.6.NS.C.7.B=>CCSS.MATH.CONTENT.6.EE.B.8
  CCSS.MATH.CONTENT.6.NS.C.7.B=>CCSS.MATH.CONTENT.6.NS.C.7.D
  CCSS.MATH.CONTENT.6.NS.C.7.C=>CCSS.MATH.CONTENT.6.NS.C.7.D
  CCSS.MATH.CONTENT.6.RP.A.1=>CCSS.MATH.CONTENT.6.RP.A.2
  CCSS.MATH.CONTENT.6.RP.A.1=>CCSS.MATH.CONTENT.6.RP.A.3.A
  CCSS.MATH.CONTENT.6.RP.A.2=>CCSS.MATH.CONTENT.6.RP.A.3.B
  CCSS.MATH.CONTENT.6.RP.A.2=>CCSS.MATH.CONTENT.6.RP.A.3.C
  CCSS.MATH.CONTENT.6.RP.A.2=>CCSS.MATH.CONTENT.6.RP.A.3.D
  CCSS.MATH.CONTENT.6.RP.A.3.A=>CCSS.MATH.CONTENT.6.RP.A.3.B
  CCSS.MATH.CONTENT.6.SP.A.1=>CCSS.MATH.CONTENT.6.SP.A.3
  CCSS.MATH.CONTENT.6.SP.A.2=>CCSS.MATH.CONTENT.6.SP.A.3
  CCSS.MATH.CONTENT.6.SP.A.2=>CCSS.MATH.CONTENT.6.SP.B.5.A
  CCSS.MATH.CONTENT.6.SP.A.2=>CCSS.MATH.CONTENT.6.SP.B.5.B
  CCSS.MATH.CONTENT.6.SP.A.2=>CCSS.MATH.CONTENT.6.SP.B.5.C
  CCSS.MATH.CONTENT.6.SP.A.2=>CCSS.MATH.CONTENT.6.SP.B.5.D
  CCSS.MATH.CONTENT.6.SP.A.3=>CCSS.MATH.CONTENT.6.SP.B.5.A
  CCSS.MATH.CONTENT.6.SP.A.3=>CCSS.MATH.CONTENT.6.SP.B.5.B
  CCSS.MATH.CONTENT.6.SP.A.3=>CCSS.MATH.CONTENT.6.SP.B.5.C
  CCSS.MATH.CONTENT.6.SP.A.3=>CCSS.MATH.CONTENT.6.SP.B.5.D
  New Questions Answered:
  ----------------------------
  standardId,correct
  CCSS.MATH.CONTENT.6.NS.C.8,1
  Output:
  CCSS.MATH.CONTENT.6.NS.C.8,LEARNED
  CCSS.MATH.CONTENT.6.NS.C.6.B,LEARNED
  CCSS.MATH.CONTENT.6.NS.C.6.A,LEARNED
  CCSS.MATH.CONTENT.5.G.A.2,LEARNED
  CCSS.MATH.CONTENT.5.G.A.1,LEARNED
  Reasoning:
  Reasoning: Correct response on CCSS.MATH.CONTENT.6.NS.C.8 means
the student knows the standard and all prerequisite standards
(CCSS.MATH.CONTENT.5.G.A.2, CCSS.MATH.CONTENT.5.G.A.1, and
CCSS.MATH.CONTENT.6.NS.C.6.B). Transitive prerequisites also include
CCSS.MATH.CONTENT.6.NS.C.6.A.
```

The prompt generated by the prompt generator 128 guides an experienced tutor i.e., AI engine 130 who needs to update a student's knowledge graph based on their responses to the adaptive test. The knowledge graph tracks the student's understanding of various educational standards, categorized as LEARNED, NOT_LEARNED, or UNKNOWN. Dependencies between standards indicate prerequisite relationships, where knowing a standard implies knowing its prerequisites, and not knowing a standard implies not knowing any dependent standards. The task is to update the status of standards based on whether the student answered a question correctly or incorrectly, following these rules. The input includes the current status of each standard, the dependencies between them, and the latest question the student answered. The AI engine 130 updates the knowledge graph accordingly and provides reasoning for the changes.

The input includes several components to update a student's knowledge graph based on their answers to the adaptive test. The student's knowledge graph tracks their understanding of various educational standards, each marked as either LEARNED, NOT_LEARNED, or UNKNOWN. Additionally, there are dependencies between these standards. The input also lists the latest questions the student has answered, specifying the standard each question pertains to and whether the student answered it correctly. In the given example, the standard statuses are listed, showing which standards the student has already learned, not learned, or for which their knowledge status is unknown. Dependencies between standards are provided, indicating prerequisite relationships that help determine how mastering one standard affects others. Lastly, the student's response to a specific standard (CCSS.MATH.CONTENT.6.NS.C.8, answered correctly) is provided to update their knowledge graph. The correct answer implies that the student knows this standard and all its prerequisite standards, leading to an update in the status of these standards from UNKNOWN or NOT_LEARNED to LEARNED.

The reasoning behind the update of the knowledge graph is based on the student's correct response to the question linked to the standard CCSS.MATH.CONTENT.6.NS.C.8. Because this standard was answered correctly, it indicates the student has learned it. Consequently, any prerequisite standards for this correctly answered standard must also be updated to LEARNED, due to the dependencies. The reasoning states that the correct response means the student knows CCSS.MATH.CONTENT.6.NS.C.8 and all its prerequisites (CCSS.MATH.CONTENT.5.G.A.2, CCSS.MATH.CONTENT.5.G.A.1, and CCSS.MATH.CONTENT.6.NS.C.6.B), along with any transitive prerequisites like CCSS.MATH.CONTENT.6.NS.C.6.A. Thus, the statuses of these standards are updated and reflected in the updated knowledge graph.

In operation 212, a selector 136 operatively coupled to the AI engine 130 selects the next educational standard for the user based on the updated knowledge graph and interdependency of the educational standards 116.

The selector 136, utilizes the power of Artificial Intelligence Natural Language Processor (AI NLP) 130 and plays a crucial role in determining the most appropriate educational standard 116 for each user from the educational database 114. The AI engine 130 employs sophisticated machine learning algorithms to enhance the accuracy of selecting the next standard by undertaking several key steps.

Initially, the collector 122 collects comprehensive user data, which includes details such as the correctness of answers, response times, and the user's progression through various educational standards. This historical data is critical for understanding the user's learning patterns and behaviors. By analyzing this data, the AI engine 130 can identify specific trends, and how users interact with different educational content.

Next, a machine learning module 138 is trained using the collected data. During this training phase, the AI engine 130 learns to recognize patterns that indicate a user's mastery level and predict the user's future performance. For instance, if a student consistently answers questions related to an Algebra topic quickly and correctly, the AI engine 130 might infer a high level of mastery in that area. Once trained, the machine learning module 138 can predict the most suitable next educational standard 116 from the educational database 114 for the user using the selector 136. This prediction is based on the user's current knowledge graph 110, which maps their existing knowledge and the dependencies between different educational standards, along with their most recent responses. For example, if a student shows very low performance in a series of optics, the AI engine 130 might recommend some topics with basics of optics in the adaptive test to boost the confidence of the user.

Furthermore, the AI engine 130 continuously refines its predictions by updating the machine learning module 138 in real time with new user responses. As the user progresses through the curriculum and answers more questions, the AI engine 130 incorporates this new data, constantly improving its ability to make accurate and personalized recommendations. This dynamic updating ensures that the AI remains responsive to the user's evolving learning needs.

By utilizing AI NLP 132, the selector 136 can interpret and processes complex user data efficiently, generating precise and contextually relevant prompts that guide and constrain the AI engine 130 in updating the current knowledge graph 110. This integration of machine learning and NLP technologies results in the online learning platform 102 that continually adjusts to provide optimal educational pathways for each user, thereby enhancing learning outcomes and user engagement.

In operation 214, the test generator 134 again generates and provides a next question, and adjusts the level of difficulty of the next question based on the response provided by the user on the first question and updated mastery levels on the educational standards 116 in the knowledge graph.

In operation 216, the AI engine 130 determines the end of the adaptive test by checking the states of the educational standards 116 considered for quizzing the user during the adaptive test.

The exemplary prompt generated by the prompt generator 128 that guides and constrains the AI engine 130 on whether the adaptive test should end or not, along with the output and the reason behind the generation of that output is given below:

### Prompt:

```
Prompt:
    ## Context
    You are an experienced educator who is determining if an
  adaptive placement test for a student has found an appropriate place
  for them to start learning effectively.
    ## Task
    You are being provided as input:
    - The student's knowledge graph of standards
      - The student's current knowledge is tracked in a knowledge
  graph that has already been updated based on any questions they've
  answered in the test.
      - The knowledge graph tracks the student's knowledge of each
  educational standard as one of the following statuses:
        - LEARNED: Indicating that the student knows the standards
        - NOT_LEARNED: Indicating the student doesn't know the
  standard
        - UNKNOWN: Indicating there is not enough information to
  make a determination.
    - The dependencies between standards in the knowledge graph.
      - These are provided in the A => B, where A is prerequisite
  to B which means,
        - If the student doesn't know A, then they don't know B as
  well.
        - If the student knows B, then they know A as well.
        - Important: This relationship is transitive, but not
  symmetric.
    - The latest questions that the student has answered on the
  placement test, including the standard it's linked to and if it was
  answered correctly or not.
        - This could be blank as well, when student is starting.
    Your task is to analyze the student's knowledge graph,
  dependencies and latest question answers and determine if the
  placement testing for the student should end, or if should we
  continue testing the student.
    ## Example 1:
    Input:
    Standard Status:
    ----------------------------
    id,grade,status
    standard.a,4,LEARNED
    standard.b,4,LEARNED
    standard.c,4,NOT_LEARNED
    standard.d,4,LEARNED
    standard.e,4,LEARNED
    standard.f,4,UNKNOWN
    standard.g,4,UNKNOWN
    standard.h,4,UNKNOWN
    standard.i,4,UNKNOWN
    standard.j,4,UNKNOWN
    standard.k,4,UNKNOWN
    standard.l,4,UNKNOWN
    standard.m,4,NOT_LEARNED
    standard.n,4,NOT_LEARNED
    standard.o,4,UNKNOWN
    standard.p,4,UNKNOWN
    standard.q,4,UNKNOWN
    standard.r,4,UNKNOWN
    Standard Dependencies:
    ----------------------------
    standard 1 => standard 2
    standard.a => standard.b
    standard.d => standard.e
    standard.i => standard.c
    standard.e => standard.m
    standard.j => standard.n
    standard.g => standard.k
    standard.l => standard.j
    standard.o => standard.p
    standard.q => standard.r
    Last Question Answered:
    ----------------------------
    standardId,correct
    standard.n,0
    Output:
    Placement Ended: No
    Reasoning: Based on the given knowledge graph and dependencies
  we can't conclude that placement for the student should continue
  hence we should continue testing.
    ## Example 2:
    Input:
    Standard Status:
    ----------------------------
    id,grade,status
    standard.a,4,LEARNED
    standard.b,4,LEARNED
    standard.c,4,NOT_LEARNED
    standard.d,4,LEARNED
    standard.e,4,LEARNED
    standard.f,4,UNKNOWN
    standard.g,4,UNKNOWN
    standard.h,4,UNKNOWN
    standard.i,4,UNKNOWN
    standard.j,4,LEARNED
    standard.k,4,UNKNOWN
    standard.l,4,UNKNOWN
    standard.m,4,NOT_LEARNED
    standard.n,4,NOT_LEARNED
    standard.o,4,UNKNOWN
    standard.p,4,UNKNOWN
    standard.q,4,UNKNOWN
    standard.r,4,UNKNOWN
    Standard Dependencies:
    ----------------------------
    standard 1 => standard 2
    standard.a => standard.b
    standard.d => standard.e
    standard.i => standard.c
    standard.e => standard.m
    standard.j => standard.n
    standard.g => standard.k
    standard.l => standard.j
    standard.o => standard.p
    standard.q => standard.r
    Last Question Answered:
    ----------------------------
    standardId,correct
    standard.n,0
    Output:
    Placement Ended: Yes
    Reasoning: Based on the given knowledge graph and dependencies,
  the student knows standard.j, which is a prerequisite for standard.n
  and doesn't know standard.n. Thus, we can conclude the placement by
  placing the student on the standard.
    ## Rules
    - Take a deep breath and work on this step by step.
    - It is mandatory to adhere to the specified output format for
  compatibility with automated parsing systems.
      - The Placement Ended section should always start with
  ‘Placement Ended:’
      - The Reasoning section should always start with ‘Reasoning:’
      - The output should only contain one Placement Ended and
  Reasoning and nothing else.
    - Important: Below are the conditions when we would complete
  the placement test.
        - When we find a standard that the student doesn't know,
  and the student knows all its pre-requisites.
        - When we find a standard that the student doesn't know,
  and it has no pre-requisites.
    - Include reasoning for output decision to justify the proposed
  decision.
    Now based on below input, determine if placement has been
  ended:
    Standard Status:
    ----------------------------
    id,grade,status
    CCSS.MATH.CONTENT.5.G.A.1,5,LEARNED
    CCSS.MATH.CONTENT.5.G.A.2,5,LEARNED
    CCSS.MATH.CONTENT.5.G.B.3,5,UNKNOWN
    CCSS.MATH.CONTENT.5.G.B.4,5,UNKNOWN
    CCSS.MATH.CONTENT.5.MD.A.1,5,UNKNOWN
    CCSS.MATH.CONTENT.5.MD.B.2,5,UNKNOWN
    CCSS.MATH.CONTENT.5.MD.C.3.A,5,UNKNOWN
    CCSS.MATH.CONTENT.5.MD.C.3.B,5,UNKNOWN
    CCSS.MATH.CONTENT.5.MD.C.4,5,UNKNOWN
    CCSS.MATH.CONTENT.5.MD.C.5.A,5,UNKNOWN
    CCSS.MATH.CONTENT.5.MD.C.5.B,5,UNKNOWN
    CCSS.MATH.CONTENT.5.MD.C.5.C,5,UNKNOWN
    CCSS.MATH.CONTENT.5.NBT.A.1,5,UNKNOWN
    CCSS.MATH.CONTENT.5.NBT.A.2,5,UNKNOWN
    CCSS.MATH.CONTENT.5.NBT.A.3.A,5,UNKNOWN
    CCSS.MATH.CONTENT.5.NBT.A.3.B,5,UNKNOWN
    CCSS.MATH.CONTENT.5.NBT.A.4,5,UNKNOWN
    CCSS.MATH.CONTENT.5.NBT.B.5,5,UNKNOWN
    CCSS.MATH.CONTENT.5.NBT.B.6,5,UNKNOWN
    CCSS.MATH.CONTENT.5.NBT.B.7,5,UNKNOWN
    CCSS.MATH.CONTENT.5.NF.A.1,5,UNKNOWN
    CCSS.MATH.CONTENT.5.NF.A.2,5,UNKNOWN
    CCSS.MATH.CONTENT.5.NF.B.3,5,UNKNOWN
    CCSS.MATH.CONTENT.5.NF.B.4.A,5,LEARNED
    CCSS.MATH.CONTENT.5.NF.B.4.B,5,UNKNOWN
    CCSS.MATH.CONTENT.5.NF.B.5.A,5,UNKNOWN
    CCSS.MATH.CONTENT.5.NF.B.5.B,5,UNKNOWN
    CCSS.MATH.CONTENT.5.NF.B.6,5,UNKNOWN
    CCSS.MATH.CONTENT.5.NF.B.7.A,5,UNKNOWN
    CCSS.MATH.CONTENT.5.NF.B.7.B,5,UNKNOWN
    CCSS.MATH.CONTENT.5.NF.B.7.C,5,UNKNOWN
    CCSS.MATH.CONTENT.5.OA.A.1,5,UNKNOWN
    CCSS.MATH.CONTENT.5.OA.A.2,5,UNKNOWN
    CCSS.MATH.CONTENT.5.OA.B.3,5,UNKNOWN
    CCSS.MATH.CONTENT.6.EE.A.1,6,UNKNOWN
    CCSS.MATH.CONTENT.6.EE.A.2.A,6,UNKNOWN
    CCSS.MATH.CONTENT.6.EE.A.2.B,6,UNKNOWN
    CCSS.MATH.CONTENT.6.EE.A.2.C,6,UNKNOWN
    CCSS.MATH.CONTENT.6.EE.A.3,6,UNKNOWN
    CCSS.MATH.CONTENT.6.EE.A.4,6,UNKNOWN
    CCSS.MATH.CONTENT.6.EE.B.5,6,UNKNOWN
    CCSS.MATH.CONTENT.6.EE.B.6,6,UNKNOWN
    CCSS.MATH.CONTENT.6.EE.B.7,6,UNKNOWN
    CCSS.MATH.CONTENT.6.EE.B.8,6,UNKNOWN
    CCSS.MATH.CONTENT.6.EE.C.9,6,UNKNOWN
    CCSS.MATH.CONTENT.6.G.A.1,6,UNKNOWN
    CCSS.MATH.CONTENT.6.G.A.2,6,LEARNED
    CCSS.MATH.CONTENT.6.G.A.3,6,UNKNOWN
    CCSS.MATH.CONTENT.6.G.A.4,6,UNKNOWN
    CCSS.MATH.CONTENT.6.NS.A.1,6,UNKNOWN
    CCSS.MATH.CONTENT.6.NS.B.2,6,UNKNOWN
    CCSS.MATH.CONTENT.6.NS.B.3,6,UNKNOWN
    CCSS.MATH.CONTENT.6.NS.B.4,6,UNKNOWN
    CCSS.MATH.CONTENT.6.NS.C.5,6,UNKNOWN
    CCSS.MATH.CONTENT.6.NS.C.6.A,6,LEARNED
    CCSS.MATH.CONTENT.6.NS.C.6.B,6,LEARNED
    CCSS.MATH.CONTENT.6.NS.C.6.C,6,UNKNOWN
    CCSS.MATH.CONTENT.6.NS.C.7.A,6,UNKNOWN
    CCSS.MATH.CONTENT.6.NS.C.7.B,6,UNKNOWN
    CCSS.MATH.CONTENT.6.NS.C.7.C,6,UNKNOWN
    CCSS.MATH.CONTENT.6.NS.C.7.D,6,UNKNOWN
    CCSS.MATH.CONTENT.6.NS.C.8,6,LEARNED
    CCSS.MATH.CONTENT.6.RP.A.1,6,UNKNOWN
    CCSS.MATH.CONTENT.6.RP.A.2,6,UNKNOWN
    CCSS.MATH.CONTENT.6.RP.A.3.A,6,UNKNOWN
    CCSS.MATH.CONTENT.6.RP.A.3.B,6,UNKNOWN
    CCSS.MATH.CONTENT.6.RP.A.3.C,6,UNKNOWN
    CCSS.MATH.CONTENT.6.RP.A.3.D,6,UNKNOWN
    CCSS.MATH.CONTENT.6.SP.A.1,6,UNKNOWN
    CCSS.MATH.CONTENT.6.SP.A.2,6,UNKNOWN
    CCSS.MATH.CONTENT.6.SP.A.3,6,UNKNOWN
    CCSS.MATH.CONTENT.6.SP.B.4,6,UNKNOWN
    CCSS.MATH.CONTENT.6.SP.B.5.A,6,UNKNOWN
    CCSS.MATH.CONTENT.6.SP.B.5.B,6,UNKNOWN
    CCSS.MATH.CONTENT.6.SP.B.5.C,6,UNKNOWN
    CCSS.MATH.CONTENT.6.SP.B.5.D,6,UNKNOWN
    Standard Dependencies:
    ----------------------------
    standard 1 => standard 2
    CCSS.MATH.CONTENT.5.G.A.1=>CCSS.MATH.CONTENT.5.G.A.2
    CCSS.MATH.CONTENT.5.G.A.1=>CCSS.MATH.CONTENT.6.NS.C.6.B
    CCSS.MATH.CONTENT.5.G.A.1=>CCSS.MATH.CONTENT.6.NS.C.6.C
    CCSS.MATH.CONTENT.5.G.A.2=>CCSS.MATH.CONTENT.6.NS.C.8
    CCSS.MATH.CONTENT.5.G.A.2=>CCSS.MATH.CONTENT.6.G.A.3
    CCSS.MATH.CONTENT.5.G.A.2=>CCSS.MATH.CONTENT.6.RP.A.3.A
    CCSS.MATH.CONTENT.5.G.B.3=>CCSS.MATH.CONTENT.5.G.B.4
    CCSS.MATH.CONTENT.5.MD.B.2=>CCSS.MATH.CONTENT.6.SP.A.1
    CCSS.MATH.CONTENT.5.MD.B.2=>CCSS.MATH.CONTENT.6.SP.A.2
    CCSS.MATH.CONTENT.5.MD.B.2=>CCSS.MATH.CONTENT.6.SP.B.4
    CCSS.MATH.CONTENT.5.MD.C.3.A=>CCSS.MATH.CONTENT.5.MD.C.4
    CCSS.MATH.CONTENT.5.MD.C.3.B=>CCSS.MATH.CONTENT.5.MD.C.4
    CCSS.MATH.CONTENT.5.MD.C.4=>CCSS.MATH.CONTENT.5.MD.C.5.A
    CCSS.MATH.CONTENT.5.MD.C.5.A=>CCSS.MATH.CONTENT.6.G.A.2
    CCSS.MATH.CONTENT.5.MD.C.5.A=>CCSS.MATH.CONTENT.5.MD.C.5.B
    CCSS.MATH.CONTENT.5.MD.C.5.B=>CCSS.MATH.CONTENT.6.G.A.2
    CCSS.MATH.CONTENT.5.MD.C.5.B=>CCSS.MATH.CONTENT.5.MD.C.5.C
    CCSS.MATH.CONTENT.5.NBT.A.1=>CCSS.MATH.CONTENT.5.NBT.A.4
    CCSS.MATH.CONTENT.5.NBT.A.1=>CCSS.MATH.CONTENT.5.NBT.B.5
    CCSS.MATH.CONTENT.5.NBT.A.1=>CCSS.MATH.CONTENT.5.NBT.B.6
    CCSS.MATH.CONTENT.5.NBT.A.1=>CCSS.MATH.CONTENT.5.NBT.B.7
    CCSS.MATH.CONTENT.5.NBT.A.1=>CCSS.MATH.CONTENT.5.NBT.A.2
    CCSS.MATH.CONTENT.5.NBT.A.2=>CCSS.MATH.CONTENT.6.EE.A.1
    CCSS.MATH.CONTENT.5.NBT.A.3.B=>CCSS.MATH.CONTENT.5.NBT.A.4
    CCSS.MATH.CONTENT.5.NBT.B.5=>CCSS.MATH.CONTENT.5.NBT.B.6
    CCSS.MATH.CONTENT.5.NBT.B.5=>CCSS.MATH.CONTENT.6.NS.B.3
    CCSS.MATH.CONTENT.5.NBT.B.6=>CCSS.MATH.CONTENT.6.NS.B.3
    CCSS.MATH.CONTENT.5.NBT.B.6=>CCSS.MATH.CONTENT.6.NS.B.2
    CCSS.MATH.CONTENT.5.NBT.B.7=>CCSS.MATH.CONTENT.5.MD.A.1
    CCSS.MATH.CONTENT.5.NBT.B.7=>CCSS.MATH.CONTENT.6.NS.B.3
    CCSS.MATH.CONTENT.5.NF.A.1=>CCSS.MATH.CONTENT.5.NBT.B.7
    CCSS.MATH.CONTENT.5.NF.A.1=>CCSS.MATH.CONTENT.5.NF.A.2
    CCSS.MATH.CONTENT.5.NF.A.1=>CCSS.MATH.CONTENT.6.EE.B.7
    CCSS.MATH.CONTENT.5.NF.A.2=>CCSS.MATH.CONTENT.5.MD.B.2
    CCSS.MATH.CONTENT.5.NF.B.3=>CCSS.MATH.CONTENT.6.RP.A.2
    CCSS.MATH.CONTENT.5.NF.B.4.A=>CCSS.MATH.CONTENT.5.NF.B.5.B
    CCSS.MATH.CONTENT.5.NF.B.4.A=>CCSS.MATH.CONTENT.5.NF.B.5.A
    CCSS.MATH.CONTENT.5.NF.B.4.B=>CCSS.MATH.CONTENT.6.G.A.1
    CCSS.MATH.CONTENT.5.NF.B.5.A=>CCSS.MATH.CONTENT.6.RP.A.1
    CCSS.MATH.CONTENT.5.NF.B.6=>CCSS.MATH.CONTENT.5.MD.B.2
    CCSS.MATH.CONTENT.5.NF.B.7.A=>CCSS.MATH.CONTENT.6.NS.A.1
    CCSS.MATH.CONTENT.5.NF.B.7.B=>CCSS.MATH.CONTENT.6.NS.A.1
    CCSS.MATH.CONTENT.5.NF.B.7.C=>CCSS.MATH.CONTENT.6.NS.A.1
    CCSS.MATH.CONTENT.5.NF.B.7.C=>CCSS.MATH.CONTENT.5.MD.B.2
    CCSS.MATH.CONTENT.5.OA.A.1=>CCSS.MATH.CONTENT.5.OA.A.2
    CCSS.MATH.CONTENT.5.OA.A.2=>CCSS.MATH.CONTENT.6.NS.B.4
    CCSS.MATH.CONTENT.5.OA.A.2=>CCSS.MATH.CONTENT.6.EE.A.3
    CCSS.MATH.CONTENT.5.OA.A.2=>CCSS.MATH.CONTENT.6.EE.A.4
    CCSS.MATH.CONTENT.5.OA.A.2=>CCSS.MATH.CONTENT.6.EE.A.2.A
    CCSS.MATH.CONTENT.5.OA.A.2=>CCSS.MATH.CONTENT.6.EE.A.2.B
    CCSS.MATH.CONTENT.5.OA.B.3=>CCSS.MATH.CONTENT.6.RP.A.1
    CCSS.MATH.CONTENT.5.OA.B.3=>CCSS.MATH.CONTENT.6.EE.C.9
    CCSS.MATH.CONTENT.6.EE.A.1=>CCSS.MATH.CONTENT.6.EE.A.2.A
    CCSS.MATH.CONTENT.6.EE.A.1=>CCSS.MATH.CONTENT.6.EE.A.2.B
    CCSS.MATH.CONTENT.6.EE.A.1=>CCSS.MATH.CONTENT.6.EE.A.2.C
    CCSS.MATH.CONTENT.6.EE.A.2.A=>CCSS.MATH.CONTENT.6.EE.A.3
    CCSS.MATH.CONTENT.6.EE.A.2.A=>CCSS.MATH.CONTENT.6.EE.B.6
    CCSS.MATH.CONTENT.6.EE.A.2.C=>CCSS.MATH.CONTENT.6.EE.A.4
    CCSS.MATH.CONTENT.6.EE.A.2.C=>CCSS.MATH.CONTENT.6.EE.B.6
    CCSS.MATH.CONTENT.6.EE.A.2.C=>CCSS.MATH.CONTENT.6.EE.B.5
    CCSS.MATH.CONTENT.6.G.A.1=>CCSS.MATH.CONTENT.6.G.A.4
    CCSS.MATH.CONTENT.6.NS.A.1=>CCSS.MATH.CONTENT.6.EE.B.7
    CCSS.MATH.CONTENT.6.NS.B.2=>CCSS.MATH.CONTENT.6.NS.B.3
    CCSS.MATH.CONTENT.6.NS.B.4=>CCSS.MATH.CONTENT.6.EE.A.3
    CCSS.MATH.CONTENT.6.NS.B.4=>CCSS.MATH.CONTENT.6.EE.A.4
    CCSS.MATH.CONTENT.6.NS.C.5=>CCSS.MATH.CONTENT.6.NS.C.6.A
    CCSS.MATH.CONTENT.6.NS.C.6.A=>CCSS.MATH.CONTENT.6.NS.C.6.B
    CCSS.MATH.CONTENT.6.NS.C.6.A=>CCSS.MATH.CONTENT.6.NS.C.6.C
    CCSS.MATH.CONTENT.6.NS.C.6.A=>CCSS.MATH.CONTENT.6.NS.C.5
    CCSS.MATH.CONTENT.6.NS.C.6.A=>CCSS.MATH.CONTENT.6.EE.B.8
    CCSS.MATH.CONTENT.6.NS.C.6.A=>CCSS.MATH.CONTENT.6.NS.C.7.C
    CCSS.MATH.CONTENT.6.NS.C.6.B=>CCSS.MATH.CONTENT.6.NS.C.8
    CCSS.MATH.CONTENT.6.NS.C.6.C=>CCSS.MATH.CONTENT.6.EE.B.8
    CCSS.MATH.CONTENT.6.NS.C.6.C=>CCSS.MATH.CONTENT.6.NS.C.7.A
    CCSS.MATH.CONTENT.6.NS.C.6.C=>CCSS.MATH.CONTENT.6.NS.C.7.B
    CCSS.MATH.CONTENT.6.NS.C.7.A=>CCSS.MATH.CONTENT.6.EE.B.8
    CCSS.MATH.CONTENT.6.NS.C.7.A=>CCSS.MATH.CONTENT.6.NS.C.7.D
    CCSS.MATH.CONTENT.6.NS.C.7.B=>CCSS.MATH.CONTENT.6.EE.B.8
    CCSS.MATH.CONTENT.6.NS.C.7.B=>CCSS.MATH.CONTENT.6.NS.C.7.D
    CCSS.MATH.CONTENT.6.NS.C.7.C=>CCSS.MATH.CONTENT.6.NS.C.7.D
    CCSS.MATH.CONTENT.6.RP.A.1=>CCSS.MATH.CONTENT.6.RP.A.2
    CCSS.MATH.CONTENT.6.RP.A.1=>CCSS.MATH.CONTENT.6.RP.A.3.A
    CCSS.MATH.CONTENT.6.RP.A.2=>CCSS.MATH.CONTENT.6.RP.A.3.B
    CCSS.MATH.CONTENT.6.RP.A.2=>CCSS.MATH.CONTENT.6.RP.A.3.C
    CCSS.MATH.CONTENT.6.RP.A.2=>CCSS.MATH.CONTENT.6.RP.A.3.D
    CCSS.MATH.CONTENT.6.RP.A.3.A=>CCSS.MATH.CONTENT.6.RP.A.3.B
    CCSS.MATH.CONTENT.6.SP.A.1=>CCSS.MATH.CONTENT.6.SP.A.3
    CCSS.MATH.CONTENT.6.SP.A.2=>CCSS.MATH.CONTENT.6.SP.A.3
    CCSS.MATH.CONTENT.6.SP.A.2=>CCSS.MATH.CONTENT.6.SP.B.5.A
    CCSS.MATH.CONTENT.6.SP.A.2=>CCSS.MATH.CONTENT.6.SP.B.5.B
    CCSS.MATH.CONTENT.6.SP.A.2=>CCSS.MATH.CONTENT.6.SP.B.5.C
    CCSS.MATH.CONTENT.6.SP.A.2=>CCSS.MATH.CONTENT.6.SP.B.5.D
    CCSS.MATH.CONTENT.6.SP.A.3=>CCSS.MATH.CONTENT.6.SP.B.5.A
    CCSS.MATH.CONTENT.6.SP.A.3=>CCSS.MATH.CONTENT.6.SP.B.5.B
    CCSS.MATH.CONTENT.6.SP.A.3=>CCSS.MATH.CONTENT.6.SP.B.5.C
    CCSS.MATH.CONTENT.6.SP.A.3=>CCSS.MATH.CONTENT.6.SP.B.5.D
    Last Question Answered:
    ----------------------------
    standardId,correct
    CCSS.MATH.CONTENT.6.NS.C.8,1
    Output:
    Placement Ended: No
    Reasoning: Based on the given knowledge graph and dependencies,
  the student answered correctly on CCSS.MATH.CONTENT.6.NS.C.8. While
  this updates the status of CCSS.MATH.CONTENT.6.NS.C.8 to LEARNED, it
  does not provide enough information to conclude the placement. There
  are still many standards with UNKNOWN status and further testing is
  necessary to accurately determine the student's knowledge and
  appropriate placement.
```

The above prompt describes a scenario where an educator i.e., the AI engine 130 needs to determine if the adaptive test for the student has correctly identified the appropriate starting point for effective learning. The AI engine 130 is provided with the student's knowledge graph, which tracks their understanding of various educational standards 116 as LEARNED, NOT_LEARNED, or UNKNOWN. Dependencies between these standards are also provided, indicating prerequisite relationships. The task involves analyzing the knowledge graph, dependencies, and the latest adaptive test answers to decide whether the adaptive test should end or continue. The decision to end the test should be based on specific conditions: if the student doesn't know an educational standard despite knowing all its prerequisites, or if they don't know an educational standard with no prerequisites. The output must follow a specified format, stating clearly whether the adaptive test has ended and providing reasoning for the decision.

The input provided to the prompt generator 128 consists of three key parts. First, the Standard Status, which is a list containing details of various educational standards, each with an ID, grade level, and status (LEARNED, NOT_LEARNED, or UNKNOWN). Here, LEARNED means the student knows the standard, NOT_LEARNED means the student does not know it, and UNKNOWN means there's insufficient information to determine if the student knows it or not. This status indicates whether the student has mastered a specific standard, has not, or if there is insufficient information to determine their knowledge. Second, the Standard Dependencies define prerequisite relationships between standards, showing which standards need to be known before others can be understood. These relationships are transitive, meaning if Standard A is a prerequisite for Standard B and Standard B for Standard C, then Standard A is indirectly a prerequisite for Standard C. Lastly, the Last Question Answered provides the ID of the most recent standard the student answered a question about, along with whether their answer was correct or not, which helps update the student's knowledge graph and further refine their proficiency.

The explanation states that even though the student answered the question related to the standard CCSS.MATH.CONTENT.6.NS.C.8 correctly, which changes the status of this standard to LEARNED, this single piece of information is insufficient to conclude the adaptive test. The reason is that there are still numerous other standards marked as UNKNOWN, meaning there isn't enough information about whether the student knows or doesn't know these standards. As a result, more testing is needed to gather enough data to accurately determine the student's knowledge level and decide on the appropriate starting point for their learning.

The pseudo-code for the ‘adaptive test generation system 100 based on varying mastery levels of the user on educational standards’ is given below:

```
# Pseudo-code for the Adaptive Placement Test Algorithm
# Function to select the next standard for the student to be
quizzed on
def select_next_standard_for_testing(knowledge_graph,
standard_dependencies, question_history, testing_instructions):
  “““
  This function uses AI to determine the next standard a
student should be quizzed on.
  It takes as input the student's knowledge graph, standard
dependencies, and the and the last standard they answered.
Additionally, testing rules are specified to guide the expected
test behavior.
  ”””
  valid_standard_selected = false
  while(!valid_standard_selected)
      # AI model invocation to predict the next standard
      next_standard =
ai_model.predict_next_standard(knowledge_graph,
standard_dependencies, question_history, testing_instructions)
        # Sanity check, and retry the AI invocation
if that fails
      valid_standard_selected = validate(next_standard)
  return next_standard
# Function to update the student's knowledge graph based on a
question response, and standard dependencies
def update_knowledge_graph(knowledge_graph,
standard_dependencies, question_response):
  “““
  Updates the student's knowledge graph based on the
correctness of their response, and uses standard dependencies
to infer knowledge of related standards
  ”””
    changes =
ai_model.get_knowledge_graph_changes(knowledge_graph,
standard_dependencies, question_response)
  knowledge_graph.update(changes)
# Function to determine the end of placement testing
def determine_end_of_placement(knowledge_graph,
standard_dependencies, conditions_to_end_testing):
  “““
  Determines if the placement testing should end based on the
student's knowledge graph, standard dependencies, and the
conditions when we want placement to end.
  ”””
  return
ai_model.check_if_placement_has_ended(knowledge_graph,
standard_dependencies, conditions_to_end_testing)
# Main algorithm flow
def adaptive_placement_test(knowledge_graph,
standard_dependencies, testing_instructions,
conditions_to_end_testing):
  “““
  The main flow of the adaptive placement test algorithm.
  ”””
  question_history = [ ]
  while not determine_end_of_placement(knowledge_graph):
    next_standard = select_next_standard(knowledge_graph,
current_standard)
    question_response = ask_question(next_standard)
    knowledge_graph =
update_knowledge_graph(knowledge_graph, standard_dependencies,
question_response )
    current_standard = next_standard
  return knowledge_graph
# Example usage of the algorithm
student_grade = 7 # Assuming the student is in 7th grade
knowledge_graph = KnowledgeGraph( ) # Initialize the knowledge
graph
final_knowledge_graph = adaptive_placement_test(student_grade,
knowledge_graph)
digraph G {
  rankdir=LR;
  nodesep=1.0;
  start [shape=ellipse, label=“Start Adaptive Placement
Test”];
  get_starting_standard [shape=box, label=“Get Starting
Standard”];
  select_next_standard [shape=box, label=“Select Next
Standard”];
  ask_question [shape=box, label=“Ask Question to Student”];
  update_knowledge_graph [shape=box, label=“Update Knowledge
Graph”];
  determine_end_of_placement [shape=diamond, label=“Determine
End of Placement”];
  end [shape=ellipse, label=“End Placement Test”];
  start −> get_starting_standard;
  get_starting_standard −> select_next_standard;
  select_next_standard −> ask_question;
  ask_question −> update_knowledge_graph;
  update_knowledge_graph −> determine_end_of_placement;
  determine_end_of_placement −> select_next_standard
[label=“Continue”];
  determine_end_of_placement −> end [label=“End Test”];
}
```

Further a feedback module 144, operatively coupled to the AI engine 130, provides real-time feedback to the user after each question. This feedback includes detailed explanations for both correct and incorrect answers, which helps enhance the user's understanding of the learning concepts. By delivering immediate, informative feedback, the feedback module 144 aids in reinforcing correct responses and clarifying misunderstandings, thereby supporting continuous learning and improvement.

In an embodiment, the adaptive test generation system 100 is further enhanced by an Application Programming Interface (API) 142 designed to seamlessly interact with the online learning platform 102. This API 142 serves several critical functions. Firstly, it sends a request to the user to initiate the adaptive test on the online learning platform 102, ensuring that the user is prompted and prepared to begin the assessment process. The API 142 connects the online learning platform 102 and the adaptive test planning module 120. The data stored in the memory 106 of the online learning platform 102 is provided to the adaptive test planning module 120 via., the API 142, when a request is raised from the user using the online learning platform 102.

Secondly, it utilizes the recommendations API 142 to select appropriate questions from a range of educational standards 116. This selection process is tailored to the user's unique learning profile 108 and current knowledge graph 110, ensuring that the questions are well-suited to assess the user's knowledge accurately. Lastly, the API 142 provides the selected questions to the user, facilitating the identification of the optimal starting standard for the user's learning journey. By strategically choosing questions from the multiple educational standards 116, the API 142 ensures a comprehensive evaluation of the user's knowledge, thereby guiding the user to the most appropriate educational standard for their continued learning and development.

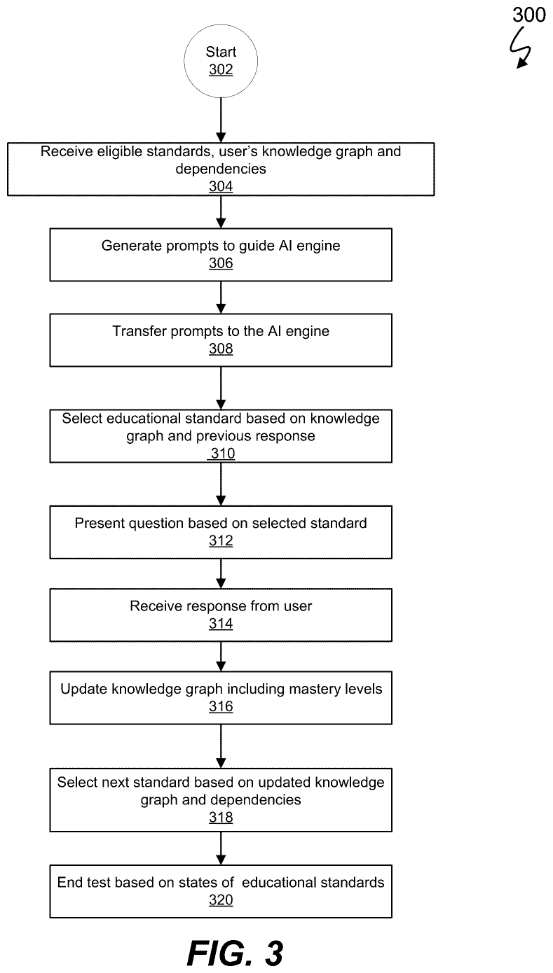

FIG. 3 depicts a flowchart 300 showing the details of the steps involved in the process of generation of an adaptive test based on varying mastery levels of the user on educational standards, which is an embodiment of the test generation process 200 of FIG. 2.

Flowchart 300 illustrates the generation of the adaptive test and the updation of the knowledge graph based on the response provided by the user during the adaptive test. The adaptive test is generated based.

Initially, the user logs 302 into the online learning platform 102. Upon login, the collector 122 retrieves 304 standards eligible for the user from the user's profile 108, along with the user's knowledge graph and dependencies 110. This data is crucial for determining which educational standards 116 are relevant to the user's current level of knowledge and learning path.

A prompt engineer provides a structure of the prompts to the prompt generator 128 which is populated by the prompt generator 128 by fetching the analyzed insights from the analyzer 124. Next, a prompt is generated 306 using the prompt generator 128 by populating the prompt structure to guide and constrain the AI engine 130. This prompt instructs the AI engine 130 to select an appropriate educational standard 116 for quizzing the user during the adaptive test. The prompt is then transferred 308 to the AI engine 130, which uses it to decide on the next standard to present to the user, ensuring that the selection is based on the current knowledge graph 110 and the user's previous test responses 112.

The AI engine 130 selects an educational standard 310 based on the user's knowledge graph 110 and previous test responses 112. The test generator 134 then presents the generated adaptive test 312 to the user through the user interface 104 of the online learning platform 102. The user takes the test, and their responses are received 314.

Following the user's responses, the knowledge graph, including mastery levels, is updated 316. This update reflects any changes in the user's mastery of the educational standards 116 based on their performance. The AI engine 130 then selects the next educational standard for the user, taking into account the updated knowledge graph and dependencies 318.

Finally, the adaptive test generation process 200 concludes when the adaptive test ends, which is determined by checking the states of the educational standards 116 considered during the adaptive test 320. This comprehensive approach ensures that the user's learning experience is continually adapted to their evolving knowledge and skills.

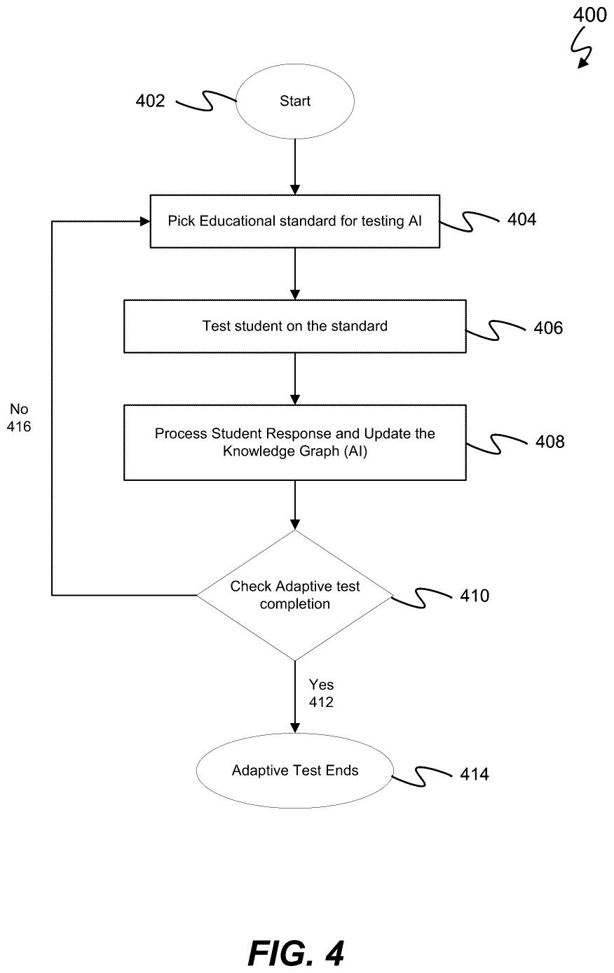

FIG. 4 depicts an adaptive test completion evaluation process 400, which is an embodiment of the adaptive test generation system 100 of FIG. 1.

The adaptive test completion evaluation process 400 illustrates the workflow of the adaptive test generation system 100, highlighting the sequence of steps from the initiation of the adaptive test to its completion. The adaptive test completion evaluation process 400 begins when the adaptive test is initiated, marked by the Start node 402. This initiation typically occurs when a user logs into the online learning platform 102 and begins the adaptive test. The adaptive test is generated by the AI engine 130 using the prompts generated by the prompt generator 128 (not shown in the figure).

Initially, the AI engine 130 selects an educational standard for the user 404 to be evaluated from the user profile details 108 stored in the memory 106 of the online learning platform 102. This selection is based on the user's current knowledge graph 110 and previous adaptive test responses data 112, ensuring the chosen educational standard aligns with the user's current level of understanding. Once the educational standard is selected, the AI engine 130 utilizes the test generator 134 (not shown in the figure), integrated within the AI engine 130 to present relevant questions to the user in the form of an adaptive test 406. The user's responses to these questions are then collected and analyzed.

After receiving the response from the user, the AI engine 130 processes the user's responses 408. The AI engine 130 assesses the correctness of the answers and updates the user's knowledge graph to reflect their mastery of the educational standards 116 using the knowledge graph updater 140. This updated knowledge graph indicates the user's strengths and weaknesses and tracks their progress.

After updating the knowledge graph, the AI engine 130 checks whether the adaptive test provided to the user is complete or not 410. This decision is based on predefined criteria, such as achieving a certain level of proficiency across various educational standards. If the AI engine 130 determines that the adaptive test is complete 412, the adaptive test completion evaluation process 400 ends 414, and the user's final proficiency is recorded. This completion is marked by the Adaptive Test Ends node. However, if the AI engine 130 determines that the adaptive test is not yet complete 416, it selects a new educational standard for the user to be tested on. The adaptive test completion evaluation process 400 then loops back to the step where the AI engine 130 picks an educational standard, and the cycle repeats. This iterative adaptive test completion evaluation process 400 continues until the AI engine 130 confirms that the user has been accurately placed.

This adaptive test generation system 100 ensures a thorough and accurate assessment of the user's curriculum and skills, guiding them to the appropriate learning path based on their performance. By dynamically adjusting the difficulty and scope of the questions based on real-time data, the adaptive test generation system 100 facilitates a personalized and effective learning experience tailored to the user's individual needs. For example, if a user consistently answers questions correctly, the AI engine 130 might select more challenging standards, whereas if the user struggles, the AI engine 130 may choose easier standards to build confidence and understanding.

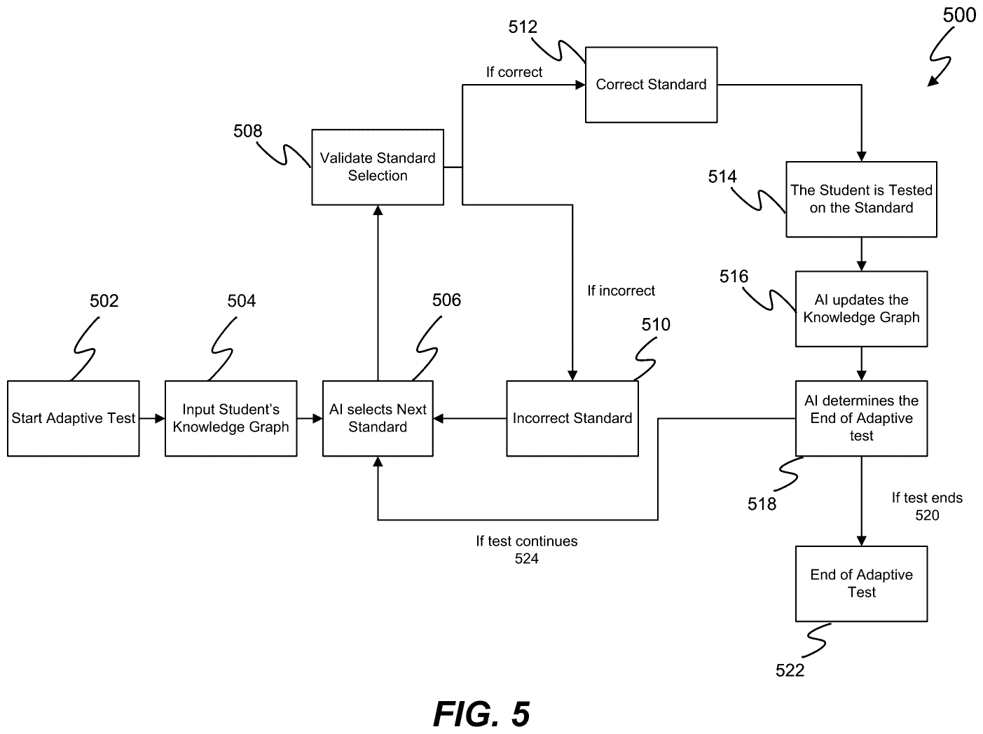

FIG. 5 depicts a knowledge graph upgradation process 500 based on the response provided by the user in an adaptive test, which is an embodiment of the adaptive test generation system 100 of FIG. 1.

The knowledge graph upgradation process 500 illustrates the workflow of an adaptive test generation system 100, illustrating the steps involved from initialization of the adaptive test to conclusion of the adaptive test. The knowledge graph upgradation process 500 begins with the ‘Start Adaptive Test’ step 502, indicating the initiation of the adaptive test. The next step involves inputting the user's knowledge graph 504, where the adaptive test planning module 120 (not shown in the figure) receives the current knowledge graph 110 of the user, detailing the mastery of the user in various educational standards 116 and the dependencies between these standards.

Following this, the AI engine 130 selects next educational standard at 506, which represents the AI engine 130 role in choosing the appropriate educational standard 116 for the user to be tested on, based on the knowledge graph. The selection is then subject to validation at the Validate Standard Selection 508, where the appropriateness of the chosen educational standard is checked. If the selected standard is incorrect 510, the knowledge graph upgradation process 500 loops back to the AI engine 130 to reselect the educational standard. If the educational standard is marked as correct 512 during the validation process, the user is presented with the set of questions in the form of an adaptive test 514 generated by the AI engine 130. The user answers questions of the adaptive test generated in correspondence to the chosen educational standard. The user's responses are then processed in the AI engine 130 and based on the response provided by the user, the knowledge graph of the user is updated 516 using the knowledge graph updater 140 (not shown in the figure). The updated knowledge graph reflects the performance of the user.

The AI engine 130 then moves to the step of determining the end of adaptive test 518, where it assesses whether the adaptive test should continue or end. If the adaptive test is considered to be complete 520, the knowledge graph upgradation process 500 moves to the ‘End Adaptive Test’ node, concluding the test 522. If the adaptive test needs to continue, the flow loops back 524 to the AI engine selecting the next educational standard, continuing the adaptive process. When the response provided by the student does not reach the pre-defined threshold values, the user is provided with the adaptive test again and again to gain mastery of that particular topic or educational standard.

For example, if a user begins the adaptive test, the adaptive test generation system 100 inputs their current knowledge graph 110, and the AI engine 130 elects an educational standard 116 based on the current knowledge graph 110. Suppose the initial educational standard is Algebra. The adaptive test planning module 120 validates this selection, and if it is considered appropriate, the user is tested on algebra-related questions. The user responses are then used to update the knowledge graph, and the AI engine 130 determines whether the adaptive test should end or if the user should be tested on another educational standard, such as geometry, calculus, and so on. This knowledge graph upgradation process 500 continues until the AI engine 130 determines the optimal proficiency level for the user.

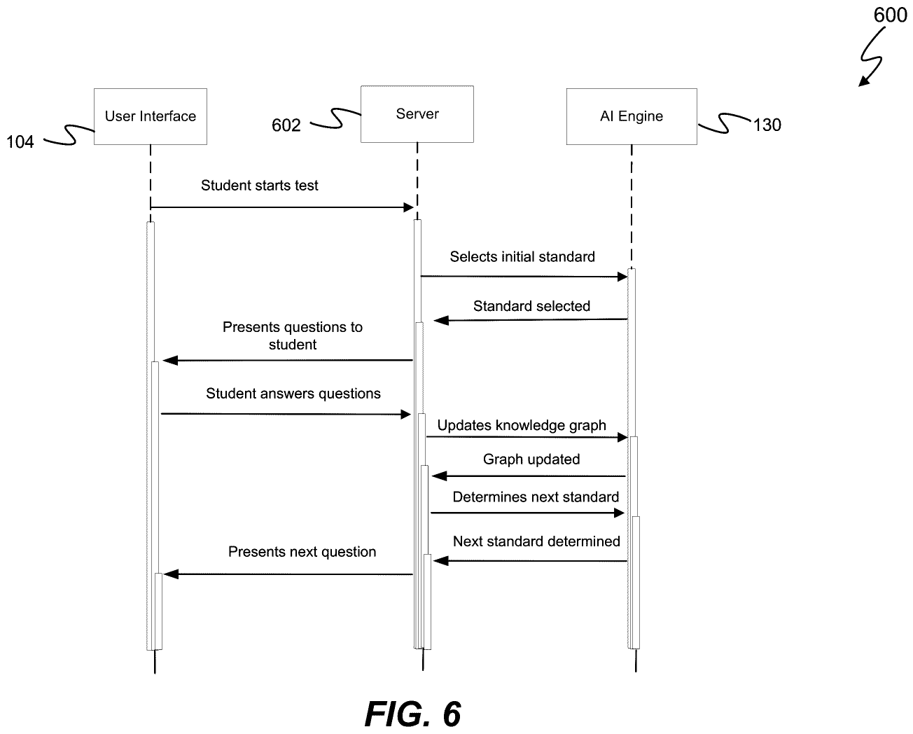

FIG. 6 depicts an adaptive test delivery process 600 to the user based on which the knowledge graph will be updated, which is an embodiment of the adaptive test generation system 100 of FIG. 1.

The adaptive test delivery process 600 illustrates the upgradation of the knowledge graph using Artificial Intelligence (AI) based on the response provided by the student in the adaptive test. When a student begins the test on the online learning platform 102 via the user interface 104, the user interface 104 sends a request to server 602 to signal the initialization of the test. The server 602 then interacts with the AI engine 130 to determine the initial educational standard 116 that is appropriate for the student based on the user profile 108, and user test response data 112 stored in the memory 106.

The AI engine 130 processes this information and selects the initial standard for the user, notifying the server 602 of this selection. When the educational standard 116 is selected by the AI engine 130, the server 602 retrieves a relevant question and presents it to the student through the user interface 104. The student answers the question on the user interface 104, which sends the response back to the server 602.

The server 602 then forwards the student's response to the AI engine 130 to update the student's knowledge graph, reflecting their current understanding and mastery of the educational standards 116. The AI engine 130 updates the knowledge graph and confirms the update to the server 602. Based on the updated knowledge graph, the server 602 asks the AI engine 130 to determine the next educational standard 116 from the educational database 114 (not shown in the figure) for the student. The AI engine 130 analyzes the updated knowledge graph and selects the next appropriate educational standard 116, informing the server 602 of this selection. Finally, the server presents the next question, aligned with the new educational standard 116, to the student via the user interface 104, thus continuing the adaptive assessment process.

The adaptive test delivery process 600 ensures a personalized assessment experience, dynamically adjusting to the student's performance and accurately identifying their curriculum level and learning needs. For example, if a student struggles with a particular concept, the AI engine 130 might select a simpler question or a related foundational educational standard 116 to help build the student's understanding before progressing further. Conversely, if the student answers correctly and quickly, the AI engine 130 may select more challenging questions to better measure the student's proficiency and place them appropriately.

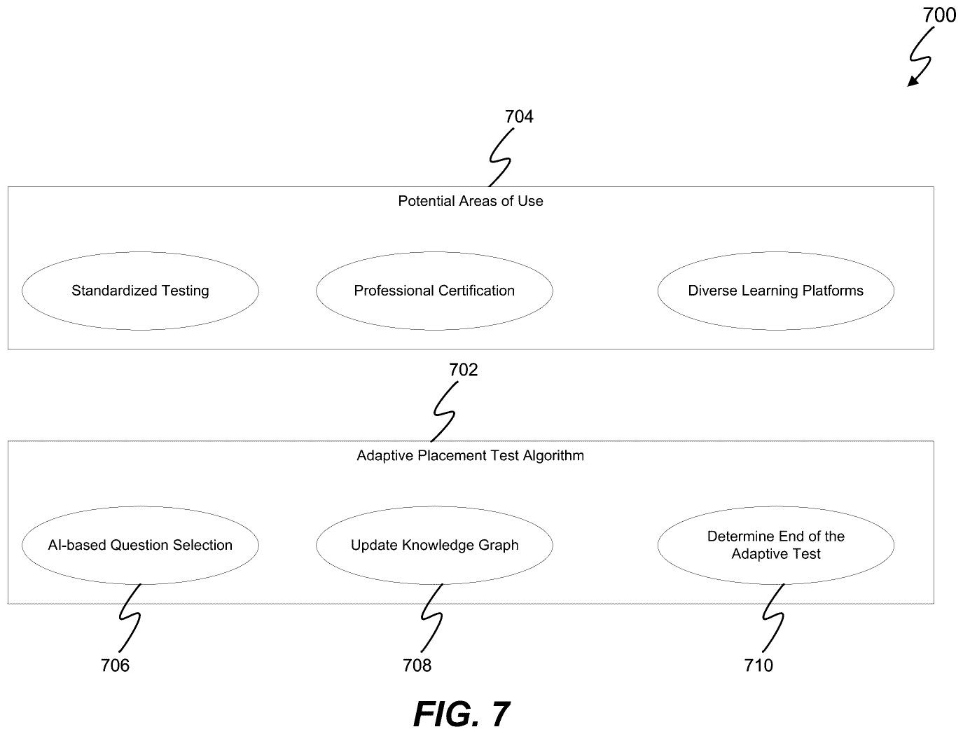

FIG. 7 depicts an exemplary block diagram 700 explaining the potential application area of the adaptive test generation system 100 based on the response provided by the user during the adaptive test.

The block diagram 700 illustrates the flow of an AI-driven adaptive test algorithm 702 and its potential areas of application 704. The primary components of the algorithm are AI-based Question Selection 706, Update Knowledge Graph 708, and Determine End of Placement 710.

The AI-based Question Selection 706 uses artificial intelligence to intelligently select the next question for the student based on their current knowledge graph 110, and recent user test response data 112. This real-time adaptation ensures that the questions are suitably challenging and relevant to the student's current level of understanding. For instance, if a student is struggling with algebra, the AI engine 130 (not shown in the figure) might choose simpler algebra problems to build the student's confidence. Conversely, for a student outclassing in geometry, the AI engine 130 might present more complex geometry questions to further improve the user's understanding to a superior level.

Following each response, the Update Knowledge Graph 708 updates the student's knowledge graph 110 to reflect the user's mastery of various educational standards 116. The knowledge graph indicates the dependencies between different standards and the student's proficiency levels. For example, if a student correctly answers a series of questions on quadratic equations, the knowledge graph updates to show increased mastery in that area, potentially unlocking more advanced topics in the curriculum.

The Determine End of Placement 710 decides when the adaptive test should conclude, based on the updated knowledge graph and the most recent student's test response data. The aim is to identify the most suitable educational standard 116 for the student to begin their learning journey. For example, if a student consistently demonstrates proficiency across a range of topics up to a certain level, the AI engine 130 may conclude the adaptive test, indicating that the student is ready to start learning at that identified level.

The algorithm has broad potential applications in various educational and professional contexts. In standardized testing, the adaptive test generation system 100 can provide a personalized assessment that accurately reflects each student's abilities. For example, in standard exams like the SAT or GRE, adaptive placement can tailor the difficulty of questions to match the test-takers skill level, offering a more precise measurement of their capabilities.

In terms of professional certification, the adaptive test generation system 100 can be used to assess and certify users' proficiency in specific skill areas. For instance, in IT certifications like IBM's Microsoft, the adaptive test can dynamically evaluate a user's knowledge and skills, ensuring they are certified at the correct level.

Diverse learning platforms can also integrate this adaptive test generation system 100 to offer personalized learning experiences. For example, platforms like Khan Academy or Coursera can utilize the adaptive placement algorithm 702 to recommend courses and modules that align with the learner's current knowledge and learning pace, thereby enhancing their overall educational experience.

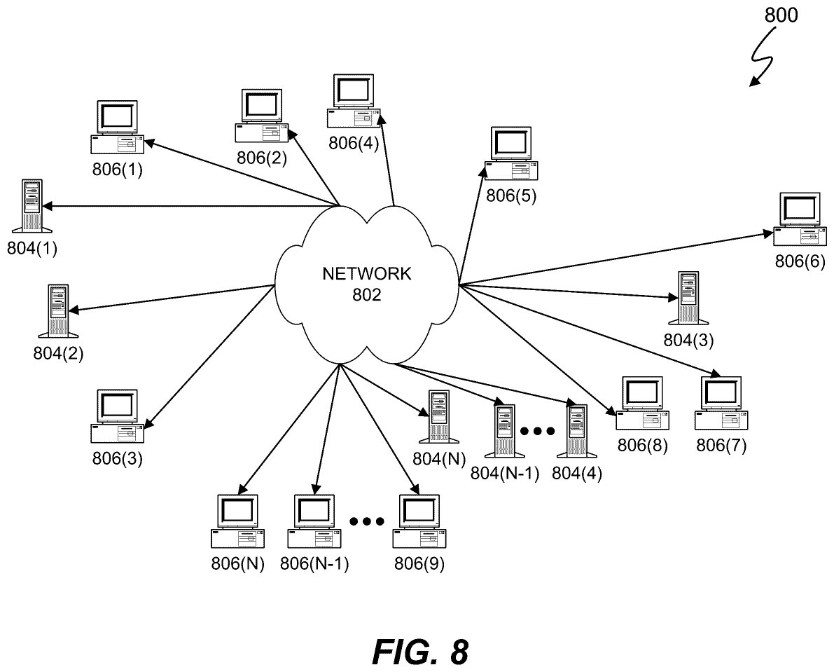

FIG. 8 is a block diagram illustrating a network environment in which a adaptive test generation system 100 and process 200 based on the response provided by the user during the adaptive test may be practiced. Network 802 (e.g. a private wide area network (WAN) or the Internet) includes several networked server computer systems 804(1)-(N) that are accessible by client computer systems 806(1)-(N), where N is the number of server computer systems connected to the network. Communication between client computer systems 806(1)-(N) and server computer systems 804(1)-(N) typically occurs over a network, such as a public switched telephone network over asynchronous digital subscriber line (ADSL) telephone lines or high-bandwidth trunks, for example, communications channels providing T1 or OC3 service. Client computer systems 806(1)-(N) typically access server computer systems 804(1)-(N) through a service provider, such as an internet service provider (“ISP”) by executing application-specific software, commonly referred to as a browser, on one of client computer systems 806(1)-(N).

Client computer systems 806(1)-(N) and/or server computer systems 804(1)-(N) are specialized computers programmed to improve conventional computer systems to implement and utilize the adaptive test generation system 100 and process 200 based on the response provided by the user during the adaptive test. The type of computer system that can be specially programmed to implement and utilize the adaptive test generation system 100 and process 200 based on the response provided by the user during the adaptive test includes a mainframe, a mini-computer, a personal computer system including notebook computers, a wireless, mobile computing device (including personal digital assistants, smartphones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as integrated or peripheral devices. In at least one embodiment, the adaptive test generation system 100 and process 200 based on the response provided by the user during the adaptive test can be implemented using code stored in a tangible, non-transient computer-readable medium and executed by one or more processors. In at least one embodiment, the adaptive test generation system 100 and process 200 based on the response provided by the user during the adaptive test can be implemented completely in hardware using, for example, logic circuits and other circuits including field programmable gate arrays.

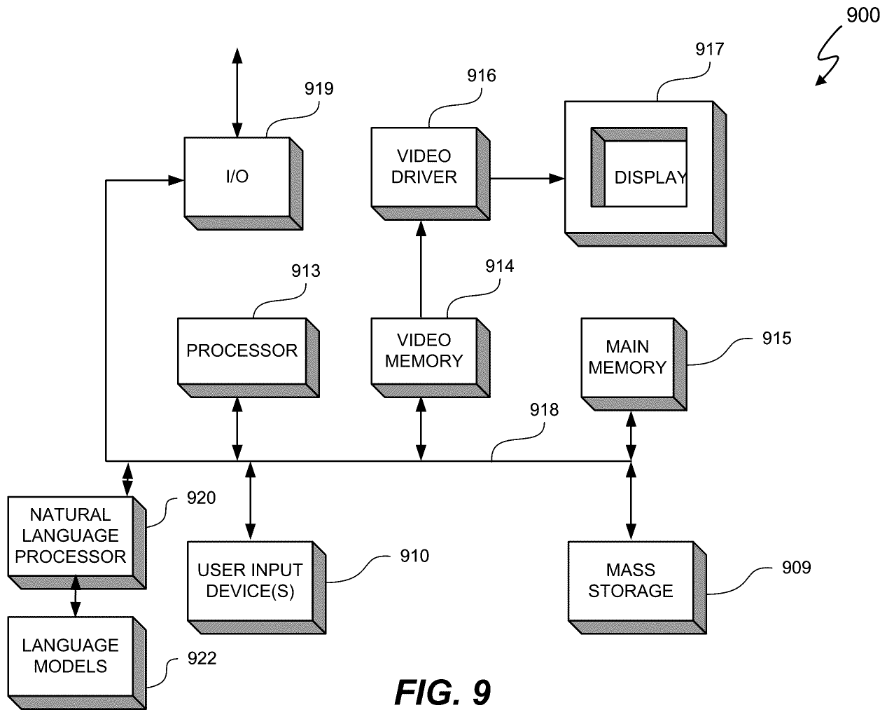

Embodiments of the adaptive test generation system 100 and process 200 based on the response provided by the user during the adaptive test can be implemented on a computer system such as a special-purpose, special-programmed computer 900 illustrated in FIG. 9. The input user device(s) 910, such as a keyboard and/or mouse, are coupled to a bi-directional system bus 918. The input user device(s) 910 are for introducing user input to the computer system and communicating that user input to processor 913. The computer system of FIG. 9 generally also includes a non-transitory video memory 914, non-transitory main memory 915, and non-transitory mass storage 909, all coupled to bi-directional system bus 918 along with input user device(s) 910 and processor 913. The mass storage 909 may include fixed and removable media, such as a hard drive, one or more CDs or DVDs, solid state memory including flash memory, and other available mass storage technology. Bus 918 may contain, for example, 32 of 64 address lines for addressing video memory 914 or main memory 915. The system bus 918 also includes, for example, an n-bit data bus for transferring DATA between and among the components, such as CPU 909, main memory 915, video memory 914, and mass storage 909, where “n” is, for example, 32 or 64. Alternatively, multiplex data/address lines may be used instead of separate data and address lines.

I/O device(s) 919 may provide connections to peripheral devices, such as a printer, and may also provide a direct connection to a remote server computer system via a telephone link or to the Internet via an ISP. I/O device(s) 919 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 909, into main memory 915 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 913, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 915 consists of dynamic random access memory (DRAM). Video memory 914 is a dual-ported video random access memory. One port of the video memory 914 is coupled to the video amplifier 916. The video amplifier 916 is used to drive the display 917. Video amplifier 916 is well-known in the art and may be implemented by any suitable means. This circuitry converts pixel DATA stored in video memory 914 to a raster signal suitable for use by display 917. Display 917 is a type of monitor suitable for displaying graphic images.

The computer system described above is for purposes of example only. The adaptive test generation system 100 and process 200 based on the response provided by the user during the adaptive test may be implemented in any type of computer system or programming or processing environment. It is contemplated that the adaptive test generation system 100 and process 200 based on the response provided by the user during the adaptive test might be run on a stand-alone computer system, such as the one described above. The adaptive test generation system 100 and process 200 based on the response provided by the user during the adaptive test might also be run from a server computer system that a plurality of client computer systems can access interconnected over an intranet network. Finally, the adaptive test generation system 100 and process 200 based on the response provided by the user during the adaptive test may be run from a server computer system that is accessible to clients over the Internet.

Although embodiments have been described in detail, it should be understood that various changes, substitutions, and alterations can be made herein without departing from the spirit and scope of the invention as defined by the appended claims.

What is claimed is:

1. A method that integrates programmatic control and a guided and constrained Artificial Intelligence (AI) engine to select an educational standard for quizzing a user during an adaptive test and updating mastery levels of the user on educational standards based on real-time responses to each question, the method comprises:
executing code using one or more processors of a computer system to cause the computer system to perform operations comprising:
receiving a list of eligible standards, the user's knowledge graph of standards, and dependencies between standards in the knowledge graph;
generating a prompt to guide and constrain the AI engine to choose an educational standard for the next question to be asked to the user in the adaptive test;
transferring the prompt to the AI engine to guide and constrain the AI engine to:
i. select an educational standard based on the current knowledge graph and the user's response received on a previous question;
ii. present a question based on the selected standard;
iii. receive a response to the presented question by the user;
iv. update the knowledge graph based on the received response, wherein updating the knowledge graph includes updating mastery levels of the user on one or more pre-requisite educational standards linked to the presented question;
v. select the next standard based on the updated knowledge graph and interdependency of the educational standards;
vi. provide a next question, wherein the level of difficulty of the next question is decided based on the response provided by the user on the first question and updated mastery levels on the educational standards in the knowledge graph; and
determining the end of the adaptive test by checking states of the educational standards considered for quizzing the user during the adaptive test.

2. The method of claim 1 wherein the mastery levels of the user on educational standards can be represented as one of the three states ‘mastered’, unmastered’, and ‘unknown’ wherein ‘mastered’ indicates that the user has mastered the educational standard, ‘unmastered’ indicates that the user has not yet mastered the educational standard, and ‘unknown’ indicates that the mastery of the user on given educational standard is unidentified.

3. The method of claim 1 further comprising:
validating the selected educational standard before providing the questions to the user, comprises:
applying a validation check to the selected educational standard to ensure its appropriateness based on the user's knowledge graph and the dependencies between educational standards;
presenting a question linked to the selected educational standard of the user, if the validity check confirms the appropriateness; and
prompting the AI engine to re-evaluate the selection criteria and choose an alternative educational standard, if the validation check fails.

4. The method of claim 1 wherein updating the knowledge graph further comprises:
evaluating the response received from the user on the presented questions;
integrating the correctness of the user's response during the adaptive test to the knowledge graph identifying if the user has mastered the educational standard assessed by the question;
updating the relationships and dependencies between educational standards in the knowledge graph based on the user's response, reflecting changes in the user's mastery level;
adjusting the knowledge graph based on the most recent question response, ensuring that the graph accurately represents the user's current knowledge state;
storing the updated knowledge graph in the educational database for future reference and continuous assessment.

5. The method of claim 1 wherein the AI engine utilizes a machine learning algorithm to refine the accuracy of selecting the next educational standard comprises:
collecting past user test response data including correctness, response time, and progression through educational standards;
training the machine learning module using the collected past user test response data to identify patterns and trends in the user learning behavior;
predicting the most suitable next educational standard for the user, taking into account the user's current knowledge graph and most recent responses using the trained machine learning module;
updating the machine learning module on a real-time basis utilizing the new response from the user to improve the prediction accuracy.

6. The method of claim 1 wherein the AI engine is configured to start testing users two grades below their current grade level to build confidence and ensure a positive initial experience.

7. The method of claim 1 maintains the difficulty level of the questions provided during the adaptive test based on the user's response patterns comprises:
analyzing the user responses, including correctness, response time, and confidence levels if available to identify the patterns in the user response;
categorizing questions into different difficulty levels based on predefined criteria such as the complexity of the educational standard, and user performance data;
adjusting the difficulty level of the next question based on the user's response, selecting easier questions if the student struggles and harder questions if the student consistently performs well.

8. The method of claim 1 checks whether to continue or end the adaptive test based on the updated knowledge graph, standard dependencies, and the user's response to the most recent question.

9. The method of claim 1 wherein real-time feedback is provided to the user after each question includes explanations for correct and incorrect answers to enhance learning on selected concepts.

10. A system that integrates programmatic control and a guided and constrained Artificial Intelligence (AI) engine to to select an educational standard for quizzing a user during an adaptive test and updating mastery levels of the user on educational standards based on real-time responses to each question, the system comprises:
one or more processors of a computer system; and
a memory, coupled to the one or more processors, storing code that when executed causes the computer system to perform operations comprising:
receiving a list of eligible standards, the user's knowledge graph of standards, and dependencies between standards in the knowledge graph;
generating a prompt to guide and constrain the AI engine to choose an educational standard for the next question to be asked to the user in the adaptive test;
transferring the prompt to the AI engine to guide and constrain the AI engine to:
select an educational standard based on the current knowledge graph and the user's response received on a previous question;
present a question based on the selected standard;
receive a response to the presented question by the user;
update the knowledge graph based on the received response, wherein updating the knowledge graph includes updating mastery levels of the user on one or more pre-requisite educational standards linked to the presented question;
select the next standard based on the updated knowledge graph and interdependency of the educational standards; and
provide a next question, wherein the level of difficulty of the next question is decided based on the response provided by the user on the first question and updated mastery levels on the educational standards in the knowledge graph; and
determining the end of the adaptive test by checking states of the educational standards considered for quizzing the user during the adaptive test.

11. The system of claim 10 wherein the system further comprises a collector configured to assess the correctness of the user's answers and record the time taken to answer each question, thereby providing detailed insights to a prompt generator.

12. The system of claim 10 further comprises a user interface integrated within an online learning platform configured to display the adaptive test generated by the AI engine based on the knowledge graph of the user.

13. The system of claim 10 wherein the system further comprises one or more databases to store past user responses such that the AI engine can refine its selection of the next educational standard based on past trends and user performance patterns.

14. The system of claim 10 wherein the knowledge graph updater is further configured to incorporate changes in the standard dependencies based on the user's performance in the adaptive test, ensuring the knowledge graph accurately reflects the user's current mastery and learning progress.

15. The system of claim 10 further comprises an Application Programming Interface (API) configured to interact with the online learning platform configured to:
sending a request to the user to initiate the adaptive test in the online learning platform;
using the recommendations API to select appropriate questions across multiple educational standards;
providing the questions to the user to identify the optimal starting standard for the user's learning journey.

16. The system of claim 10 wherein the test generator is configured to create a variety of question types, including multiple-choice, short answer, and interactive questions, to assess the user's knowledge across different formats.

17. The system of claim 10 further comprises:
a feedback module operatively coupled to the AI engine configured to provide real-time feedback to the user after each question, including explanations for correct and incorrect answers to enhance learning concepts.
